(19) United States
(12) Patent Application Publication
(10) Pub. No.: US 2025/0324366 A1
(43) Pub. Date: Oct. 16, 2025

(54) METHODS AND DEVICES FOR WAKE-UP SIGNAL

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 18/870,520

(22) PCT Filed: Jun. 2, 2022
(86) PCT No.: PCT/CN2022/096855

§ 371 Date: Nov. 29, 2024

(51) Int. Cl. H04W 52/02; H04L 27/26

(52) U.S. Cl. CPC H04W 52/0235; H04L 27/2636

(57) ABSTRACT

Embodiments of the present disclosure relate to methods and devices for wake-up signals. A method implemented at a network device comprises forming an OOK subsequence with multiple OOK symbols that comprise at least one OOK ON-symbol and at least one OOK OFF-symbol. The multiple OOK symbols are associated with one OFDM symbol. The method further comprises mapping the OOK subsequence into multiple pre-Discrete Fourier Transform (pre-DFT) subsequences respectively to form a pre-DFT sequence, and performing transform precoding on the pre-DFT sequence. The method further comprises mapping output of the transform precoding into frequency resources allocated to a Wake-up Signal (WUS) and generating the WUS, and transmitting to a terminal device the WUS.

### TECHNICAL FIELD

Embodiments of the present disclosure generally relate to the field of telecommunication, and in particular, to methods and devices for wake-up signals.

### BACKGROUND

For a user equipment (UE) in Radio Resource Control (RRC) idle/inactive state, the periodic paging monitoring and measurement consume considerable power at UE side, which is critical for the power limited devices, e.g., the Internet of Things (IoT) devices, wearable devices, etc.

A study for low power wake-up signal (WUS) is required, which may study and evaluate techniques of low power signals and low power receivers, to enable extreme low power consumption and low wake-up latency.

### SUMMARY

In general, example embodiments of the present disclosure provide methods and devices for wake-up signals.

In a first aspect, there is provided a method implemented at a network device. The method comprises generating at least one On-Off Keying (OOK) ON-symbol by using a first number of frequency resources mapped with non-zero values. The non-zero values are used for a normal downlink (DL) transmission. The method also comprises generating at least one OOK OFF-symbol by using a second number of frequency resources mapped with zero values or near zero values. The method also comprises generating a Wake-up Signal (WUS) based on the at least one OOK ON-symbol and the at least one OOK OFF-symbol and transmitting to a terminal device the WUS.

In a second aspect, there is provided a method implemented at a network device. The method comprises forming an OOK subsequence with multiple OOK symbols that comprise at least one OOK ON-symbol and at least one OOK OFF-symbol. The multiple OOK symbols are associated with one OFDM symbol. The method further comprises mapping the OOK subsequence into multiple pre-Discrete Fourier Transform (pre-DFT) subsequences respectively to form a pre-DFT sequence. The method further comprises performing transform precoding on the pre-DFT sequence and mapping output of the transform precoding into frequency resources allocated to a Wake-up Signal (WUS) and generating the WUS. The method further comprises transmitting to a terminal device the WUS. Length of the pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In a third aspect, there is provided a method implemented at a terminal device. The method comprises receiving from a network device a Wake-up Signal (WUS). The method further comprises detecting the WUS to determine multiple On-Off Keying (OOK) symbols that comprise at least one OOK ON-symbol and at least one OOK OFF-symbol. The at least one OOK ON-symbol is generated based on a first number of frequency resources mapped with non-zero values. The non-zero values used for a normal downlink (DL) transmission. The at least one OOK OFF-symbol is generated based on a second number of frequency resources mapped with zero values or near zero values.

In a fourth aspect, there is provided a method implemented at a terminal device. The method comprises receiving from a network device a Wake-up Signal (WUS). The method further comprises detecting the WUS to determine multiple On-Off Keying (OOK) symbols that comprise at least one OOK ON-symbol and at least one OOK OFF-symbol. The WUS is generated based on an output of transform precoding of a pre-Discrete Fourier Transform (pre-DFT) sequence, and the pre-DFT sequence comprises multiple pre-DFT subsequences. The pre-DFT sequence is generated based on an OOK subsequence, and the OOK subsequence comprises the multiple OOK symbols. The multiple OOK symbols are associated with one OFDM symbol. Moreover, length of a pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In a fifth aspect, there is provided a method implemented at a terminal device. The method comprises receiving from a network device a downlink (DL) signal comprising a Wake-up Signal (WUS) and a normal downlink (DL) transmission. The LP-WUS and the normal DL transmission are generated using an Orthogonal Frequency Division Multiplexing (OFDM) operation. The method further comprises receiving from the network device a WUS configuration and determining resources for the WUS indicated in the WUS configuration. The method further comprises determining overlapped resources which are allocated to the normal DL transmission and overlapped with the resources for the WUS and determining that the overlapped resources are not available for the normal DL transmission.

In a sixth aspect, there is provided a method implemented at a terminal device. The method comprises receiving from a network device a downlink (DL) signal comprising a Wake-up Signal (WUS) and a normal downlink (DL) transmission. The WUS comprises multiple On-Off Keying (OOK) symbols comprising at least one OOK ON-symbol and at least one OOK OFF-symbol. The at least one OOK ON-symbol is generated based on data of the normal DL transmission. The method further comprises determining indices of multiple PRBs allocated for the WUS and determining that Resource Elements (REs) of the multiple PRBs of an OFDM symbol associated with an OOK ON-symbol are available for the normal DL transmission. The method further comprises determining that REs of the multiple PRBs of the OFDM symbol associated with an OOK OFF-symbol are not available for the normal DL transmission.

In a seventh aspect, there is provided a network device. The network device comprises a processor and a memory storing instructions. The memory and the instructions are configured, with the processor, to cause the network device to perform the method according to the first and second aspects.

In an eighth aspect, there is provided a terminal device. The terminal device comprises a processor and a memory storing instructions. The memory and the instructions are configured, with the processor, to cause the terminal device to perform the method according to the third, fourth, fifth and sixth aspects.

In a ninth aspect, there is provided a computer readable medium having instructions stored thereon. The instructions, when executed on at least one processor of a device, cause the device to perform the method according to the first, second, third, fourth, fifth and sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication system in which implementations of the present disclosure can be implemented;

FIG. 2 illustrates an example process of generation of a WUS signal according to some example embodiments of the present disclosure;

FIG. 3 illustrates an example signaling chart showing an example process of WUS in accordance with some embodiments of the present disclosure;

FIG. 4 illustrates an example signaling chart showing another example process of WUS in accordance with some embodiments of the present disclosure.

FIG. 5A illustrate an example transmitter for the WUS in accordance with some embodiments of the present disclosure;

FIG. 5B illustrate an example receiver for the WUS in accordance with some embodiments of the present disclosure;

FIG. 6 illustrates an example diagram of OFDM symbols in a subframe for 15 KHz subcarrier spacing (SCS) in accordance with some embodiments of the present disclosure;

FIG. 7A illustrates an example diagram of OOK ON-symbol generation in accordance with some embodiments of the present disclosure;

FIG. 7B illustrates another example diagram of OOK ON-symbol generation in accordance with some embodiments of the present disclosure;

FIG. 7C illustrates another example diagram of OOK ON-symbol generation in accordance with some embodiments of the present disclosure;

FIG. 8A illustrates an example diagram of OOK OFF-symbol generation in accordance with some embodiments of the present disclosure;

FIG. 8B illustrates another example diagram of OOK OFF-symbol generation in accordance with some embodiments of the present disclosure;

FIG. 9A illustrates an example diagram of OOK symbols generation based on the Discrete Fourier Transform-spread OFDM (DFT-s-OFDM) waveform in accordance with some embodiments of the present disclosure;

FIG. 9B illustrates another example diagram of OOK symbols generation based on the DFT-s-OFDM waveform in accordance with some embodiments of the present disclosure;

FIG. 10 illustrates an example diagram of an OOK sequence with a Cyclic Prefix (CP) being handled as a useful part of an OOK symbol in accordance with some embodiments of the present disclosure;

FIG. 11 illustrates an example diagram of the OOK sequence of FIG. 9 with a Guard Interval (GI) inserted, in accordance with some embodiments of the present disclosure;

FIG. 12 illustrates an example diagram of an OOK sequence with a CP being handled as a useless part of an OOK symbol in accordance with some embodiments of the present disclosure;

FIG. 13 illustrates an example diagram of an OOK sequence that duration of a CP and duration of the OOK sequence are different, in accordance with some embodiments of the present disclosure;

FIGS. 14A and 14B illustrate example diagrams of an OOK sequence with filling data inserted between non-contiguous OOK symbols in accordance with some embodiments of the present disclosure;

FIG. 15 illustrates a flowchart of an example method implemented at a network device in accordance with some embodiments of the present disclosure;

FIG. 16 illustrates a flowchart of another example method implemented at a network device in accordance with some embodiments of the present disclosure;

FIG. 17 illustrates a flowchart of an example method implemented at a terminal device in accordance with some embodiments of the present disclosure;

FIG. 18 illustrates a flowchart of another example method implemented at a terminal device in accordance with some embodiments of the present disclosure;

FIG. 19 illustrates a flowchart of another example method implemented at a terminal device in accordance with some embodiments of the present disclosure; and

FIG. 20 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, a study for low power wake-up signal (WUS) is required. OOK modulation is widely considered in the study, due to the very simple receiver architecture and ultra-low power consumption. With OOK modulation, the receiver may only need to detect the envelop/energy of the time domain signal with a relatively low sampling rate, and without complicated baseband processing.

IEEE 802.11ba introduces a low power wake-up mechanism to the WIFI system that adopts a multiple carriers OOK modulation. In 802.11ba, the OOK on-symbol and off-symbol are generated based on a CP-OFDM symbol, and the duration of CP-OFDM is 4 us.

However, the New Radio (NW) system may have different requirements form the WIFI system. For example, the NR may mainly focus on idle/inactive mode, need to get good tradeoff between power saving and wake-up latency, and may not provide same coverage as normal DL/uplink (UL) transmissions.

Moreover, the existing NR channels/signals are based on OFDM waveform which cannot coexist with the OOK directly. Therefore, the WUS signal may be generated independently to other OFDM based channels/signals. However, considering the complexity and the spectrum efficiency, it will be beneficial to reuse the OFDM framework to generate the WUS signal. For example, if the WUS and normal DL channels (e.g., Physical Downlink Control Channel (PDCCH), Physical Downlink Shared Channel (PDSCH)) are synchronized and use same OFDM numerology, then they are orthogonal in frequency domain, therefore a guard band may be avoided or reduced. In addition, the time boundaries of WUS and other DL symbols can be well aligned, and it is beneficial to get good resource utilization.

There will be some issues if we use the same method as the IEEE 802.11ba. For example, the CP-OFDM symbol of NR is much longer than WIFI (e.g., about 71 us for NR 15 KHz SCS), and using such a long OOK symbol may cause low spectrum efficiency; multiple SCS are supported by NR, the duration of a CP-OFDM symbol may depend on the numerology; and CP lengths of OFDM symbols in a slot may be not same, e.g., the 0^{th} and 7^{th} symbols may have longer CP than other symbols for 15 KHz SCS.

In this disclosure, OOK modulation is only an example, other amplitude modulation, e.g., an Amplitude Shift Keying (ASK), can also be used. The term “OOK symbol” can also be replaced by “modulation symbol”, “OOK ON-symbol” can be replaced by “symbol with higher amplitude” and “OOK OFF-symbol” can be replaced by “symbol with lower amplitude or zero amplitude”.

Embodiments of the present disclosure propose a method for generating low power wake-up signals. In this solution, a common OFDM operation is used for both WUS and other DL transmissions. The WUS only occupies part of the channel bandwidth, and is multiplexed with other DL transmissions in frequency domain, and then spectrum efficiency can be improved.

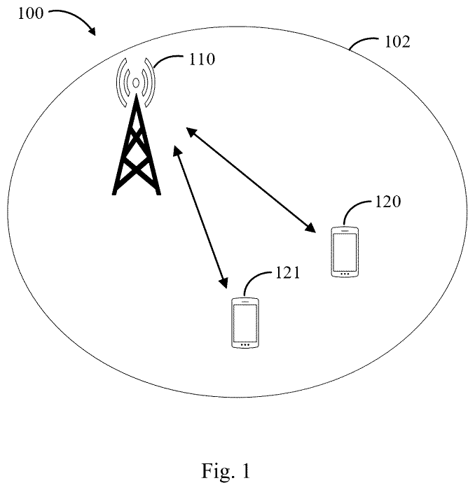

Principle and implementations of the present disclosure will be described in detail below with reference to FIGS. 1 to 20. In some embodiments, the general configuration (e.g., time/frequency resources) for WUS is described. Some embodiments describe how to generate OOK symbols, if considering one CP-OFDM symbol as one OOK symbol. Moreover, some embodiments describe how to generate OOK symbols, if considering one CP-OFDM symbol as multiple OOK symbols.

FIG. 1 shows an example communication system 100 in which embodiments of the present disclosure can be implemented. The system 100 includes terminal devices (e.g., UEs) 120 and 121 and a network device (e.g., base station (BS)) 110 that serves the terminal devices 120 and 121. A serving area of the network device 110 is called as a cell 102. It is to be understood that the number of network devices and terminal devices is only for the purpose of illustration without suggesting any limitations. The system 100 may include any suitable number of network devices and terminal devices adapted for implementing embodiments of the present disclosure.

In some embodiments, the terminal device 120 may be in a RRC idle/inactive state and monitor a WUS from the network device 110, while the terminal device 121 may be in a RRC connected/active state and receive DL transmissions from the network device 110. In some embodiments, the terminal device 121 may be indicated resources for the WUS in order to avoid the potential resource collision between the WUS and other DL transmissions.

Communications in the communication system 100 may be implemented according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

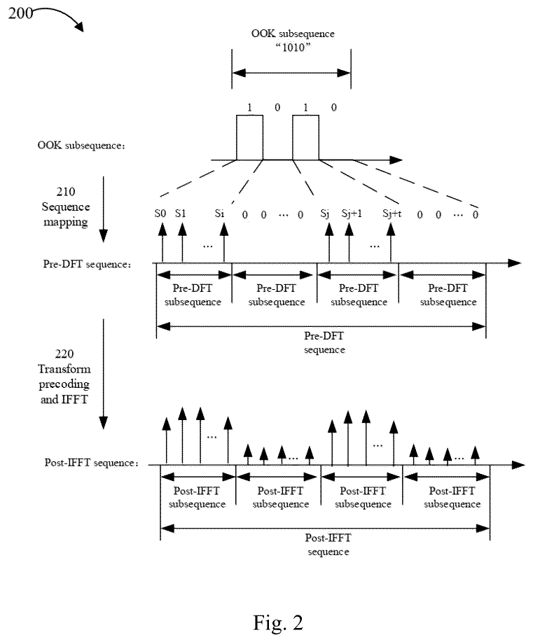

FIG. 2 illustrates an example process 200 of generation of a WUS signal according to some example embodiments of the present disclosure. Some terminologies will be described by referring to FIG. 2. By way of example, FIG. 2 shows an OOK subsequence containing of four OOK symbols “1010,” where an OOK symbol could be an OOK ON-symbol (denoted by “1”) or an OOK OFF-symbol (denoted by “0”), an OOK sequence is a sequence of OOK symbols, and an OOK subsequence is a continuous portion of an OOK sequence. In some embodiments, an OOK sequence is mapped into multiple OFDM symbols, and an OOK subsequence is a portion of the OOK sequence and mapped into an OFDM symbol of the multiple OFDM symbols. In some embodiments, the term “map” indicates transformation or association, for example, mapping an OOK sequence into multiple OFDM symbols may mean that the OOK sequence is transformed into the multiple OFDM symbols (i.e., the multiple OFDM symbols are generated based on the OOK sequence), or the OOK sequence is associated with the multiple OFDM symbols.

As shown in FIG. 2, a pre-Discrete Fourier Transform (pre-DFT) sequence is obtained by performing a sequence mapping 210 on the OOK subsequence. After sequence mapping 210, each OOK symbol in the OOK subsequence is mapped into a pre-DFT subsequence, and the multiple pre-DFT subsequences associated with the OOK symbols in the OOK subsequence are concatenated into a pre-DFT sequence.

After a transform precoding and Inverse Fast Fourier Transform (IFFT) operation 220, a pre-DFT sequence is transformed into a post-IFFT sequence. A post-IFFT subsequence is a continuous portion of the post-IFFT sequence. A post-IFFT subsequence can be seen as a transformation from a corresponding pre-DFT subsequence approximatively. A post-IFFT subsequence associated with an OOK OFF-symbol has relatively small power and a post-IFFT subsequence associated with an OOK ON-symbol has relatively large power. In some embodiments, the IFFT operation can be replaced by Inverse Discrete Fourier Transform (IDFT).

In addition, after a DFT (also called transform precoding) operation, a pre-DFT sequence is transformed into a post-DFT sequence. It is an intermedium stage between the pre-DFT sequence and the post-IFFT sequence, and not showed in FIG. 2.

Then, a WUS signal may comprise at least one post-IFFT sequence, and optionally with other signals (e.g., CP, GI, filling data or signal generated based on filling data, etc.).

In summary, a post-IFFT sequence, a pre-DFT sequence and an OOK subsequence are associated with each other; a post-IFFT subsequence, a pre-DFT subsequence and an OOK symbol are associated with each other; a post-IFFT subsequence can be seen as an oversampling version of the associated pre-DFT subsequence, and a post-IFFT sequence can be seen as an oversampling version of the associated pre-DFT sequence.

Please note that, in the present disclosure, if not specified otherwise, the term “OFDM symbol” indicates CP-OFDM symbol, or any variant of OFDM symbol, e.g., GI-OFDM, zero CP OFDM, unique word OFDM, etc. And the term “OFDM without CP” indicate the output of IFFT and the CP or guard interval is not inserted yet.

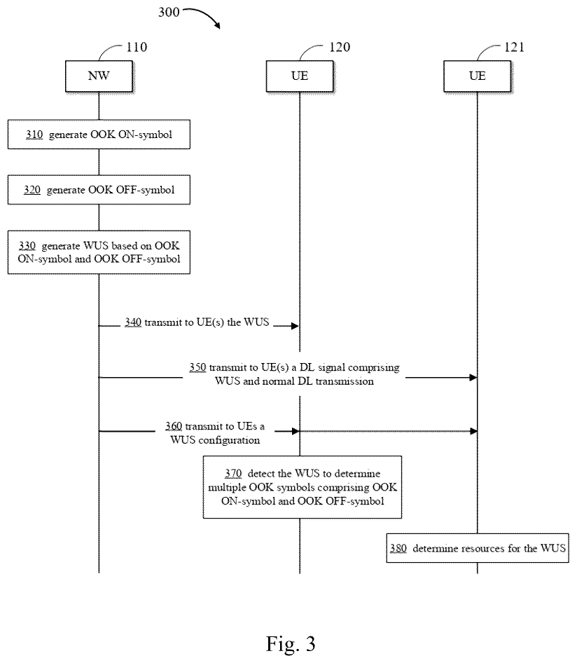

FIG. 3 illustrates an example signaling chart showing an example process 300 of WUS in accordance with some embodiments of the present disclosure. For the purpose of discussion, the process 300 will be described with reference to FIG. 1. The process 300 may involve the network (NW) device 110 and the terminal devices 120 and 121 (i.e., UE 120 and UE 121) as illustrated in FIG. 1. Although the process 300 has been described in the communication system 100 of FIG. 1, this process may be likewise applied to other communication scenarios.

As shown in FIG. 3, the NW 110 generates 310 at least one OOK ON-symbol and generates 320 at least one OOK OFF-symbol. In some embodiments, the OOK ON-symbol or OOK OFF-symbol is generated based on an OFDM symbol generation which is also used for a normal DL transmission (e.g., PDCCH, PDSCH, Channel State Information-Reference Signal (CSI-RS), etc.).

In some embodiments, multiple subcarriers can be used for the OOK symbol generation. For example, a first number of subcarriers mapped with non-zero values can be used to generate an OOK ON-symbol. The non-zero values can be complex-valued symbols which are dedicated for WUS, or the non-zero values can be values also used for the normal DL channels or DL signals (e.g., PDCCH, PDSCH, Demodulation Reference Signal (DMRS), CSI-RS, positioning RS, etc.). Moreover, a second number of subcarriers mapped with zero values or near-zero values can be used to generate an OOK OFF-symbol. The near-zero values have smaller power than the non-zero values used for the OOK ON-symbol. The number of the first plurality of subcarriers and the number of the second plurality of subcarriers can be different.

After the OOK at least one ON-symbol and at least one OOK OFF-symbol are generated, the NW 110 generates 330 the WUS based on the generated OOK ON-symbol and OOK OFF-symbol.

With this OOK symbol generation mechanism, the WUS can only occupy part of the channel bandwidth and can be multiplexed with other DL transmissions in frequency domain. Thus, the spectrum efficiency can be improved. Moreover, a common OFDM operation can be used for both the WUS and other DL transmissions, and the WUS can be orthogonal with the normal DL transmission, therefore a guard band between the WUS and the normal DL transmission can be reduced. For example, at least for the OOK ON-symbol, there can be no guard band, because the inter-carrier-interference from the normal DL transmission to the WUS is actually useful for the OOK symbol detection since it boosts the power level of the OOK ON-symbol at receiver side. There may be no interference from the WUS to the normal DL transmission since they are generated by a common OFDM operation.

Frequency domain resources for the WUS will be described. In some embodiments, the WUS may occupy a plurality of subcarriers or Physical Resource Blocks (PRBs), e.g., 100 subcarriers or 200 subcarriers, or 4PRBs, 8PRBs, 16PRBs, 24PRBs, or 32PRBs, etc.

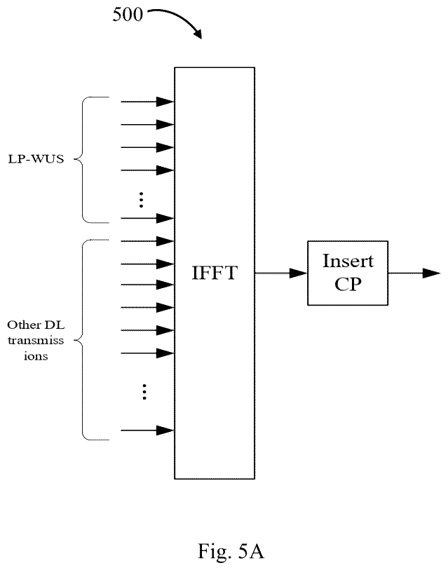

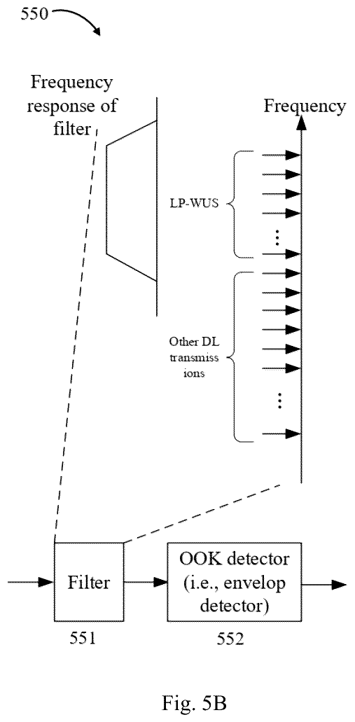

Reference is now made to FIG. 5A and FIG. 5B. FIG. 5A shows an example transmitter 500 for the WUS that may be comprised in the network device 110. FIG. 5B which shows an example receiver 450 of the WUS that may be comprised in the terminal devices 120 and 121.

At the transmitter 500 side, the NW 110 generates the WUS and a normal DL transmission by a common OFDM generation operation. Then, as shown in FIG. 3, the NW 110 transmits 340 to the UE 120 the WUS. In some embodiments, the NW 110 transmits 350 to the UE 121 a DL signal that comprises the WUS and the normal DL transmission. In some embodiments, the NW 110 may also transmit to the UE 120 the WUS in a DL signal that comprises the normal DL transmission. At the receiver 550 side, the UE 120 may use a filter 551 (e.g., a band-pass filter) to suppress the interference from other DL transmissions to the WUS, and then uses an OOK detector 452 to detect the WUS symbols.

In some embodiments, the WUS may occupy the frequency resource at the bandwidth edge, in other words, the PRBs allocated for the WUS may be the first M PRBs (i.e., the lower bandwidth edge), or the last M PRBs (i.e., the upper bandwidth edge) of a channel bandwidth, where M is an integer. Alternatively or in addition, a subset of the subcarriers of the M PRBs are in the guard band of the channel bandwidth, in other words, a subset of the subcarriers of the M PRBs are not available subcarriers for other DL transmissions.

The benefit to allow the WUS located at the bandwidth edge or at the guard band may be at least to save the potential guard band between the WUS and other DL transmissions, because only one side guard band may be needed between the WUS and other DL transmissions.

In some embodiments, the UE 120 may be indicated a bandwidth configuration to monitor the WUS. If the UE 120 does not receive the bandwidth configuration, the UE 120 may assume that the frequency resources of the WUS are the central/upper-edge/lower-edge M PRBs of a default bandwidth part (BWP) (e.g., the initial BWP or a preconfigured BWP). Alternatively or in addition, the frequency resources of the WUS may be the central/upper-edge/lower-edge M PRBs of the channel bandwidth, where the channel bandwidth may be indicated by the NW 110 in the system information.

Time domain resources for the WUS will be described. In some embodiments, the duration of a WUS may be equal to or not larger than N continuous OFDM symbols (a guard duration may be reserved before or after the WUS signal, and the guard duration may be also in the N OFDM symbols), where N is an integer and N may be associated with the numerology for the OFDM symbol, for example, N may be equal to s*2\hat{ }u, where u is the numerology parameter which is an integer and s is an integer.

In some embodiments, a WUS may start at the OFDM symbol with an index from 0, 1, 2, 3, . . . , 7*2\hat{ }u in a subframe, and end at a OFDM symbol not later than OFDM symbol with an index of 7*2\hat{ }u in a subframe. In other word, a WUS signal may be within the first half subframe, or within the first half subframe plus the first OFDM symbol of the second half subframe. Alternatively, a WUS signal may start at the OFDM symbol with an index from 7*2\hat{ }u, (7*2\hat{ }u)+1, (7*2\hat{ }u)+2, . . . , (14*2\hat{ }u)−1 in a subframe, and end at a OFDM symbol not later than OFDM symbol with an index of (14*2\hat{ }u)−1 in a subframe. In other word, a WUS signal may be within the second half subframe.

This may be because the symbol 0 and symbol 7*2\hat{ }u have longer CP than other OFDM symbols in a subframe. If the WUS signal cross the symbol 0 or symbol 7*2\hat{ }u, then the durations of OOK symbols may be not unique, this may degrade the receiver performance.

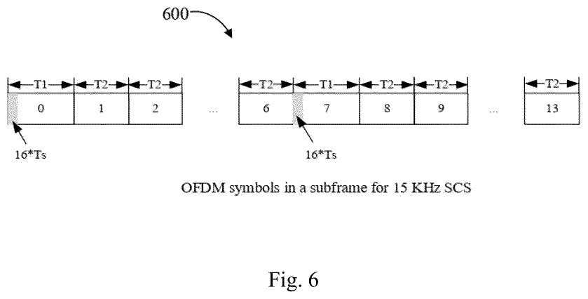

Reference is now made to FIG. 6, which illustrates an example diagram 600 of OFDM symbols in a subframe for 15 KHz SCS (i.e., u=0,) in accordance with some embodiments of the present disclosure.

In some embodiments, for 15 KHz SCS, a WUS signal may contain 7 OOK symbols, and the duration of each OOK symbol may be equal to the duration of an OFDM symbol, and the 7 OOK symbols may be aligned with OFDM symbol 7 to OFDM symbol 13 respectively.

As shown in FIG. 6, the symbol 7 is longer than other symbols. However, it has no impact on the WUS detector since the detector may determine the duration of the first OOK symbol based on the boundary between the first and second OOK symbols.

In some embodiments, if the numerology is 30 KHz SCS, to align with the 15 KHz case, a WUS signal can still contain 7 OOK symbols, and the duration of each OOK symbol may be equal to the duration of two OFDM symbols. As an example, the first OOK symbol may be aligned with the OFDM symbol 14 and the OFDM symbol 15, and the second OOK symbol may be aligned with the OFDM symbol 16 and the OFDM symbol 17, and so on. As shown in FIG. 6, T1=T2+16*Ts, where Ts is reference sampling duration.

Alternatively, for the 15 KHz SCS, a WUS signal may contain N OOK symbols and N is smaller than 7, and the duration of each OOK symbol may be equal to an OFDM symbol, and the N OOK symbols may be aligned with N continuous OFDM symbol of the last 7 OFDM symbols of a subframe.

Reference is now made back to FIG. 3. For a UE in RRC idle/inactive state (e.g., UE 120), the NW 110 may transmit 360 to the UE 120 a WUS configuration in the system information.

In some embodiments, the WUS configuration may comprise a frequency domain resource configuration. The frequency domain resource configuration may indicate a plurality of PRBs or subcarriers where the WUS signal occupies. For example, the frequency domain resources configuration may indicate the index of the first PRB/subcarrier of the WUS and the number of PRBs/subcarriers for the WUS. If the number of PRBs/subcarriers is not indicated, a predefined/default value may be used by the UE 120. Alternatively or in addition, the frequency domain resources configuration may indicate one of the following candidate resource configurations: the WUS occupies the first M PRBs of a BWP or a channel bandwidth, the WUS occupies the last M PRBs of a BWP or a channel bandwidth, the WUS occupies the central M PRBs of a BWP or a channel bandwidth, or the BWP or the channel bandwidth is a default or preconfigured BWP or channel bandwidth.

In some embodiments, the WUS configuration may comprise a sequence configuration. The sequence configuration may indicate one of the following contents: the sequence length (i.e., the number of OOK symbols in a sequence), duration of an OOK symbol, or a sequence ID which indicate an OOK sequence from a plurality of predefined OOK sequences.

In some embodiments, the WUS configuration may further comprise a time domain resource configuration. The time domain resource configuration may indicate one of the following contents: the periodicity of the WUS, the duty cycle of the WUS, or the number of OOK symbols mapped into an OFDM symbol.

In some embodiments, for a UE in RRC connected sate (e.g., UE 121), it may not be required to monitor WUS. However, it can still be indicated the resource for the WUS, in order to avoid the potential resource collision between the WUS and other DL transmissions. Therefore, the NW 110 may transmit 360 to the UE 121 a WUS configuration via a RRC information element. The above described information for the idle/inactive UE can be reused for the connected UE. Besides, the time domain resource configuration may also indicate N continuous OFDM symbols in a slot or a subframe which may be used for the WUS.

In some embodiments, an OOK ON-symbol or an OOK OFF-symbol may be mapped into a single OFDM symbol. Specifically, a portion of the subcarriers of an OFDM symbol may be used to generate an OOK symbol, and the other subcarriers may be used for other DL transmissions. With these approaches, it is very simple to generate the OOK symbols by utilizing the existing OFDM signal generation. Further, it is easy to achieve symbol/slot/subframe alignment between the WUS signal and other DL transmissions.

Reference is now made back to FIG. 3. The UE 120 detects 370 the WUS to determine multiple OOK symbols that comprise at least one OOK ON-symbol and at least one OOK OFF-symbol, using for example the detector 552.

In some embodiments, the UE 121 determines 380 resources for the WUS. For example, the UE 121 may determine resources for the WUS indicated in the WUS configuration. The UE 121 may be indicated the time and frequency resources for the WUS. If the resources of other DL transmissions are overlapped with the resources allocated to the WUS, the UE 121 may determine the overlapped resources are not available for other DL transmissions.

Alternatively or in addition, if the OOK ON-symbol is generated based on the data for other DL transmissions, the UE 121 may determine indices of multiple PRBs allocated to the WUS. For a particular slot where the WUS is mapped, the UE 121 may determine the sequence of the WUS (i.e., the OOK sequence) in this slot. The UE 121 may determine that the Resource Elements (REs) of the M PRBs of an OFDM symbol associated with an OOK ON-symbol are available for other DL transmissions and determine that the REs of the M PRBs in an OFDM symbol associated with an OOK OFF-symbol are not available for other DL transmissions.

In some embodiments, the OOK sequence may be indicated by Downlink Control Information (DCI) format (e.g., by DCI format 1-0, 1-1, or 1-2), which schedules a PDSCH for the UE 121. Alternatively or in addition, the UE 121 may determine that the OOK sequence is based on a preemption indication (e.g., by DCI format 2-1). Where S bits preemption indication may be used, and each bit of the S bits may represent a symbol group, where the symbol group may include at least one continuous OFDM symbols. A bit value “0”/“1” may indicate that the corresponding symbol group is associated with OOK ON-symbol (i.e., the corresponding symbol group and M PRBs are available for other DL transmissions), and a bit value “1”/“0” may indicate that the corresponding symbol group is associated with OOK OFF-symbol (i.e., the corresponding symbol group and M PRBs are not available for other DL transmissions).

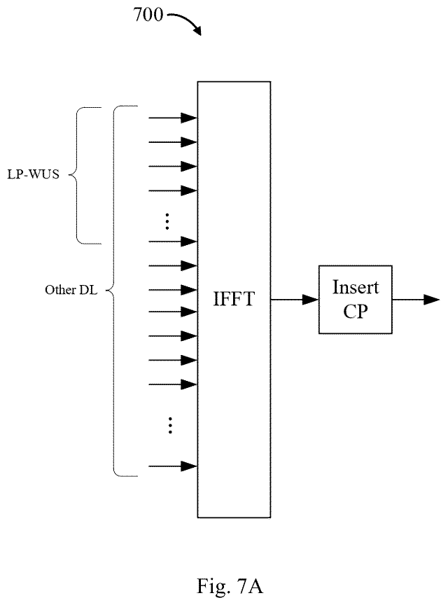

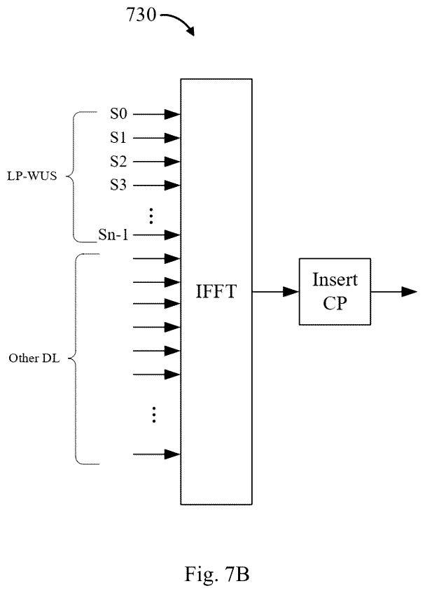

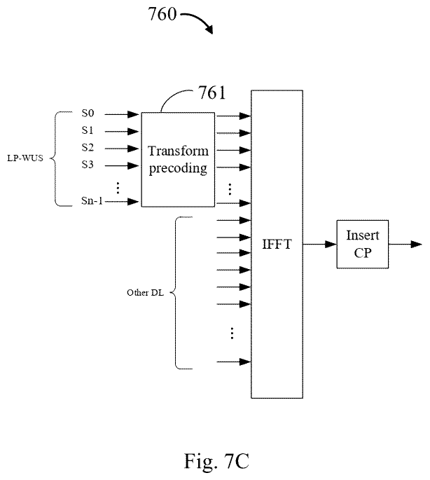

FIG. 7A illustrates an example diagram 700 of the OOK ON-symbol generation in accordance with some embodiments of the present disclosure. In FIG. 7A, the NW 110 may generate the OOK ON-symbols based on other DL transmissions.

In this case, the M PRBs allocated for the WUS are actually mapped with the data of other DL transmissions, e.g., PDSCH, PDCCH, CSI-RS, DMRS, etc., and these DL transmissions may transmitted to for example the UE 121. The feasibility of this method may lie in that the OOK detector only detect the envelop or the energy of the OOK symbols, and it is not impacted by the values of the data mapped to the M PRBs.

FIG. 7B illustrates an example diagram 730 of the OOK ON-symbol generation in accordance with some embodiments of the present disclosure. In FIG. 7B, the NW 110 may generate the OOK ON-symbols based on a dedicated sequence for the WUS.

In this case, a sequence, e.g., {S0, S1, S2, . . . , Sn−1}, may be mapped to the M PRBs to generate the OOK ON-symbols. The element of the sequence could be a complex-valued symbol, e.g., a Binary Phase Shift Keying (BPSK), a Quadrature Phase Shift Keying (QPSK), 16 Quadrature Amplitude Modulation (QAM) or 64QAM symbol, or the sequence could be a Zadoff-Chu (ZC) sequence or a computer generated sequence.

FIG. 7C illustrates an example diagram 760 of the OOK ON-symbol generation in accordance with some embodiments of the present disclosure. In FIG. 7C, the NW 110 may generate the OOK ON-symbols based on a dedicated sequence with transform precoding 761 for the WUS.

In this case, a sequence, e.g., {S0, S1, S2, . . . , Sn−1}, may be performed with the transform precoding 761 (e.g., a DFT processing) firstly, and then the outputs of transform precoding may be mapped to the M PRBs to generate the OOK ON-symbol.

For the OOK ON-symbol generation methods in FIGS. 7A-7C, a guard band may be not needed between the WUS and other DL transmissions. For an OOK ON-symbol, any signal component which increases the power is beneficial for detection. Therefore, at the receiver side, the power leakage from other DL transmissions to the WUS has no harmful impact on the envelop or energy detector. On the contrary, the leakage may increase the detected power of the WUS ON-symbol. On the other hand, for a UE receiving the other DL transmissions, since the WUS and other DL transmissions are generated with a common OFDM operation, there may be no interference from the WUS to other DL transmissions at the receiver side.

As described above, zero or near zero values (i.e., values with smaller power than other DL transmissions or the dedicated sequence for OOK ON-symbols) are mapped to the M PRBs allocated for the WUS, to generate the OOK OFF-symbol. Different from the OOK ON-symbol, the power leakage from other DL transmissions may have negative impact on the OOK OFF-symbol detection at receiver side.

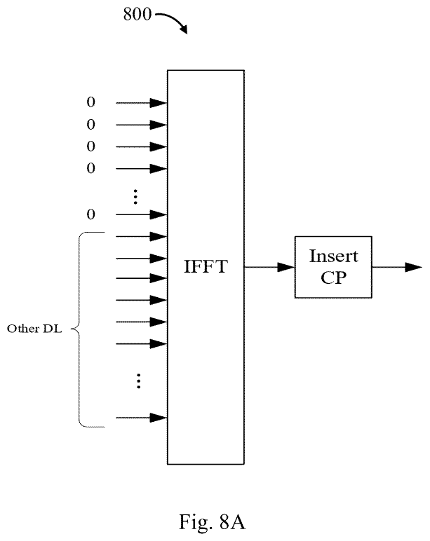

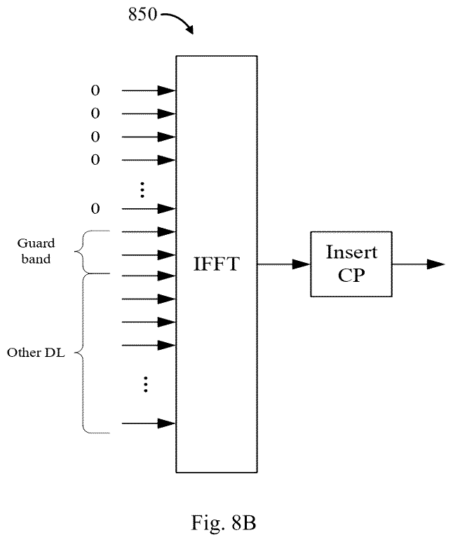

FIG. 8A illustrates an example diagram 800 of the OOK OFF-symbol generation in accordance with some embodiments of the present disclosure. In FIG. 8A, no guard band is reserved between the WUS and other DL transmissions. In this case, it may be implemented at the receiver side how to handle the interference from other DL transmissions to WUS, e.g., using a narrower band pass filter, using interference suppression algorithms, etc.

FIG. 8B illustrates an example diagram 850 of the OOK OFF-symbol generation in accordance with some embodiments of the present disclosure. In FIG. 8B, a guard band is reserved between the WUS and other DL transmissions. In some embodiments, the guard band may be filled with zero values or near zero values. Alternatively or in addition, the guard band may be filled with non-zero values, and the non-zero values may be based on the data of other DL transmissions, e.g., the guard band could be filed with the data for frequency domain spectrum shaping for other DL transmissions.

In some embodiments, the OOK ON-symbol and OFF-symbol can be generated based on the DFT-s-OFDM waveform, and can be orthogonal with other DL transmissions. In some embodiments, a single OFDM symbol can be mapped into multiple OOK symbols. In some embodiments, the CP can be handled as a useful part of an OOK symbol. Alternatively, the CP can be handled as useless part of an OOK symbol.

With these approaches, the WUS and normal DL transmissions can be frequency division multiplied, and thus spectrum efficiency can be improved. Moreover, multiple OOK symbols can be mapped into a single OFDM symbol, therefore longer OOK sequence may be used for a specific duration, and it may be beneficial for the detection performance.

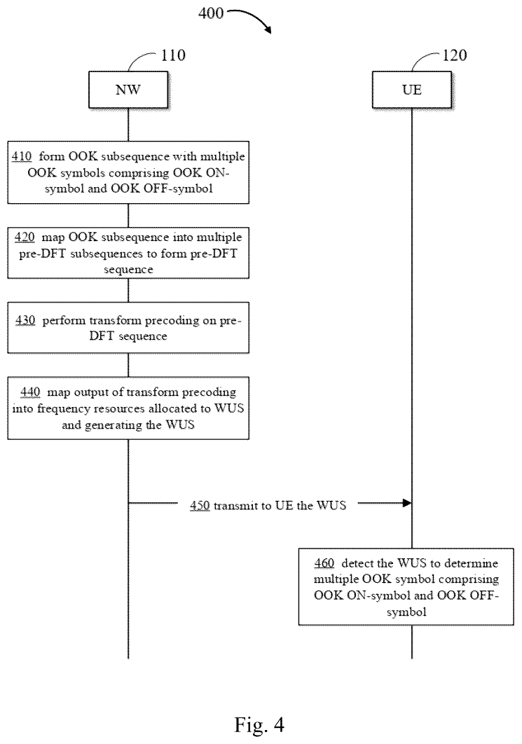

Reference is now made to FIG. 4. FIG. 4 illustrates an example signaling chart showing another example process 400 of WUS in accordance with some embodiments of the present disclosure. For the purpose of discussion, the process 400 will be described with reference to FIG. 1. The process 400 may involve the network (NW) device 110 and the terminal device 120 (i.e., UE 120) as illustrated in FIG. 1. Although the process 400 has been described in the communication system 100 of FIG. 1, this process may be likewise applied to other communication scenarios.

As shown in FIG. 4, the NW 110 forms 410 an OOK subsequence with multiple OOK symbols that comprise at least one OOK ON-symbol and at least one OOK OFF-symbol. The multiple OOK symbols can be associated with one OFDM symbol. The NW 110 maps 420 the OOK subsequence into multiple pre-DFT subsequences respectively to form a pre-DFT sequence. Then, the NW 110 performs 430 transform precoding on the pre-DFT sequence. Further, the NW 110 maps 440 output of the transform precoding into frequency resources allocated to the WUS and generates the WUS. Length of the pre-DFT subsequence in the multiple pre-DFT subsequences can be associated with at least one of: a number of subcarriers used for the WUS, a number of the multiple OOK symbols, or an index of the pre-DFT subsequence in the multiple pre-DFT subsequences.

Moreover, the NW 110 transmits 450 to the UE 120 the WUS. The UE 120 detects 460 the WUS to determine multiple OOK symbols that comprise at least one OOK ON-symbol and at least one OOK OFF-symbol. In some embodiments, the WUS is generated based on an output of transform precoding of a pre-DFT sequence, and the pre-DFT sequence comprises multiple pre-DFT subsequences. The pre-DFT sequence is generated based on an OOK subsequence, and the OOK subsequence comprises the multiple OOK symbols. The multiple OOK symbols are associated with one OFDM symbol. Moreover, length of a pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

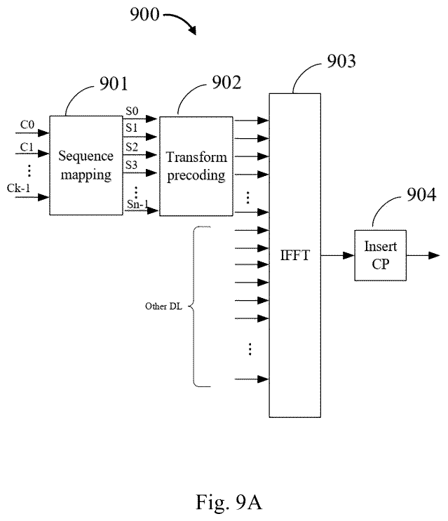

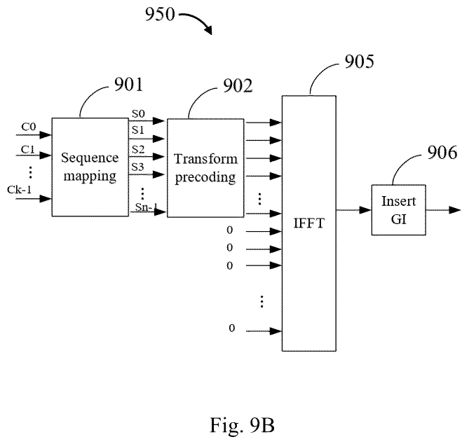

Details of the WUS generation and detection illustrated in FIG. 4 will be described by referring to FIGS. 9A to 14B. FIGS. 9A and 9B illustrate the OOK symbols generation based on the DFT-s-OFDM waveform in accordance with some embodiments of the present disclosure. FIG. 9A is generally indicated as 900, and FIG. 9B is generally indicated as 950. In some embodiments, k OOK symbols can be mapped into one OFDM symbol, and the k OOK symbols may form an OOK subsequence, i.e., {C0, C1, C2, . . . , Ck−1}, where k is an integer larger than 1, and OOK symbol Ci (0<=i<k) is equal to 0 or 1.

As shown in FIGS. 9A and 9B, the OOK subsequence may be mapped 901 into a pre-DFT sequence, i.e., {S0, S1, S2, . . . , Sn−1}, and a pre-DFT sequence may include k pre-DFT subsequences. In other words, each OOK symbol in the OOK subsequence may be mapped 901 into a pre-DFT subsequence.

Then the pre-DFT sequence may be performed with the transform precoding 902 (i.e., a DFT transform), and the output of transform precoding may be mapped into the M PRBs allocated to WUS.

In some embodiments, as shown in FIG. 9A, other DL transmissions and the WUS may be performed with a single IFFT operation 903, and then may be inserted a CP 904.

In some embodiments, as shown in FIG. 9B, the WUS may be performed with an independent IFFT operation 905, and then a GI may be inserted 906 before the front of the output of the IFFT. The length of the GI may be same as the length of CP for other DL transmissions. The GI can be zero value samples, a dedicated sequence, a copy or a transformation of a particular part of the output of the IFFT, or a CP.

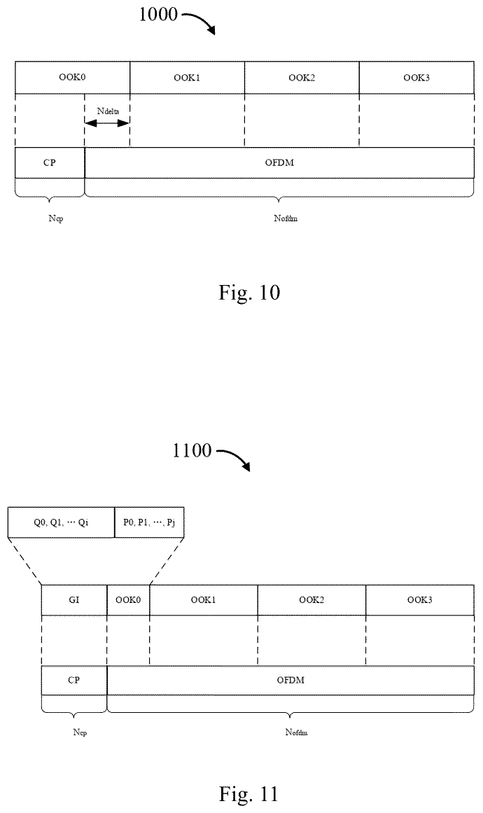

Now discuss the case that the CP is handled as a useful part of an OOK symbol. FIG. 10 illustrates an example diagram 1000 of an OOK sequence with the CP of the OFDM symbol being handled as a useful part of an OOK symbol.

In FIG. 10, it is assumed that the number of subcarriers used for the WUS is N_{wus}, the length of the OFDM symbol without CP is N_{ofdm} samples, and the length of CP is N_{cp} samples. Then the ideal length of each OOK symbol should be: (N_{ofdm}+N_{cp})/k, i.e., 1/k of the length of OFDM symbol. However, there may be only N_{ofdm} samples after the IFFT transformation, therefore CP may be considered in the OOK sequence mapping.

As described above, an OOK subsequence may be mapped into k pre-DFT subsequence. Specifically, each OOK symbol in the OOK subsequence is mapped into a pre-DFT subsequence. However, the length of the pre-DFT subsequences may be different. In particular, the first pre-DFT subsequence may be shorter than the others. The length of the k pre-DFT subsequences may be determined based on N_{ofdm}, N_{cp}, k and N_{wus}, and the difference between the length of the first pre-DFT subsequence and any of the other subsequences may be associated with the length of CP.

For example, the length of the pre-DFT subsequence other than the first pre-DFT subsequence (denoted by N₁) may be determined based on the aforementioned ideal length ((N_{ofdm}+N_{cp})/k) and a scaling factor (N_{wus}/N_{ofdm}). N₁ can be provided as:

$${N}_{1} = ( {N}_{ofdm} + {N}_{cp} ) / k * {N}_{wus} / {N}_{ofdm} , or \qquad ( 1 )$$

$${N}_{1} = floor [ ( {N}_{ofdm} + Ncp ) / k * {N}_{wus} / {N}_{ofdm} ] , or \qquad ( 2 )$$

$${N}_{1} = ceil [ ( {N}_{ofdm} + {N}_{cp} ) / k * {N}_{wus} / {N}_{ofdm} ] . \qquad ( 3 )$$

Where the floor[ ] is a function that gives the largest integer less than or equal to input as output, and the ceil[ ] is a function that gives the smallest integer greater than or equal to input as output.

Moreover, the length of the first pre-DFT subsequence (denoted by No) may be determined based on the ideal length ((N_{ofdm}+N_{cp})/k), the CP length, and a scaling factor (N_{wus}/N_{ofdm}). Alternatively, N₀ maybe based on N_{wus} and N1 directly. N₀ can be provided as:

$${N}_{0} = {N}_{wus} - ( k - 1 ) * {N}_{1} , or \qquad ( 4 )$$

$${N}_{0} = [ ( {N}_{ofdm} + {N}_{cp} ) / k - {N}_{cp} ] * {N}_{wus} / {N}_{ofdm} , or \qquad ( 5 )$$

$${N}_{0} = floor \{ [ ( {N}_{ofdm} + {N}_{cp} ) / k - {N}_{cp} ] * {N}_{wus} / {N}_{ofdm} \} , or \qquad ( 6 )$$

$${N}_{0} = ceil \{ [ ( {N}_{ofdm} + {N}_{cp} ) / k - {N}_{cp} ] * {N}_{wus} / {N}_{ofdm} \} . \qquad ( 7 )$$

After the IFFT and before the CP insertion, an OFDM symbol without CP may be generated, and it may include k post-IFFT subsequences, and each of the k post-IFFT subsequence may be associated with an OOK symbol.

FIG. 11 illustrates an example diagram 1100 of the OOK sequence of FIG. 10 with a GI inserted, in accordance with some embodiments of the present disclosure. In FIG. 11, the length of the first post-IFFT subsequence may be shorter than others, and the first post-IFFT subsequence is denoted as {P0, P1, . . . , Pj}, where j=(N_{ofdm}+N_{cp})/k−N_{cp}−1. Then, a GI may be inserted before the front of the output of IFFT, suppose that the GI sequence is {Q0, Q1, . . . , Qi}, and i=N_{cp}−1.

In some embodiments, the GI sequence may be generated based on the first post-IFFT subsequence. For example, if i<=j, then {Q0, Q1, . . . , Qi} may be equal to the first (i+1) samples or the last (i+1) samples of {P0, P1, . . . , Pj}. Alternatively, if i>j, then {P0, P1, . . . , Pj} may be repeated and truncated to (i+1) samples, to generate {Q0, Q1, . . . , Qi}.

In some embodiments, the GI sequence may be generated based on the first post-IFFT subsequence with inversed order. For example, if i<=j, then {Q0′, Q1′, . . . , Qi′} may be equal to the first (i+1) samples or last (i+1) samples of {P0, P1, . . . , Pj}, and {Q0, Q1, . . . , Qi}={Qi′, Qi−1′, . . . , Q0′}. Alternatively, if i>j, then {P0, P1, . . . , Pj} may be repeated and truncated to (i+1) samples, to generate {Q0′, Q1′, . . . , Qi′}, and {Q0, Q1, . . . , Qi}={Qi′, Qi−1′, . . . , Q0′}.

Alternatively, the above GI sequence generation may be performed only if the first OOK symbol of the k OOK symbols is an OOK ON-symbol. If the first OOK symbol of the k OOK symbols is an OOK OFF-symbol, all elements of the GI sequence may be zero values or near zero values.

Alternatively or in addition, if the first OOK symbol and the last OOK symbol are same, i.e., both are OOK OFF-symbol or OOK ON-symbol, then, {Q0, Q1, . . . , Qi} may be the last (i+1) samples of the last post-IFFT subsequence. In other words, the GI may be inserted as a normal CP processing. In some embodiments, the OOK sequence can be designed to have same value of the first and last OOK symbol in an OOK subsequence.

For purpose of illustration without suggesting any limitations, an example is given below. Suppose that the SCS is 15 KHz, and 24 PRBs (i.e., 288 subcarriers) are used for WUS, and 4 OOK symbols are mapped into an OFDM symbol. Assume that the IFFT size is 2048, CP length is 144 samples, then, for the last 3 symbols of the OOK subsequence, each of the symbols can be mapped to a pre-DFT sequence with length of:

$$floor \{ [ ( 2048 + 144 ) / 4 ] * 288 / 2048 \} = 77.$$

The first symbol of the OOK subsequence can be mapped to a pre-DFT sequence with length of: 288-3*77=57.

In this case, the OOK symbols may be generated by the following steps:
Step 1: generate the four pre-DFT subsequences based on the four OOK symbols with the above length, and concatenate them into a pre-DFT sequence with a length of 288 point;
Step 2: the 288-point pre-DFT sequence may be performed with a 288-point DFT processing, and then a 288-point post-DFT sequence may be generated;
Step 3: the 288 elements of the post-DFT sequence may be then mapped to the 288 subcarriers of the 24PRBs respectively, and then a 2048-point IFFT may be performed to generate an OFDM symbol without CP with 2048 samples; and
Step 4: a 144 point GI may be generated and inserted in the front of the 2048 samples.

Based on this method, the duration of an OFDM symbol (i.e., 2048+144=2192 samples) may be roughly divided into four parts averagely (i.e., ˜2192/4=548 samples), and each of the four parts may represent an OOK symbol.

Now discuss the case that the CP is handled as a useless part of an OOK symbol. In this case, it is assumed that the WUS receiver (e.g., the receiver 550) is capable to identify and remove the CP/GI, and the OOK symbols are only mapped to the useful part of OFDM symbol, i.e., CP/GI is not a useful part of the OOK symbols.

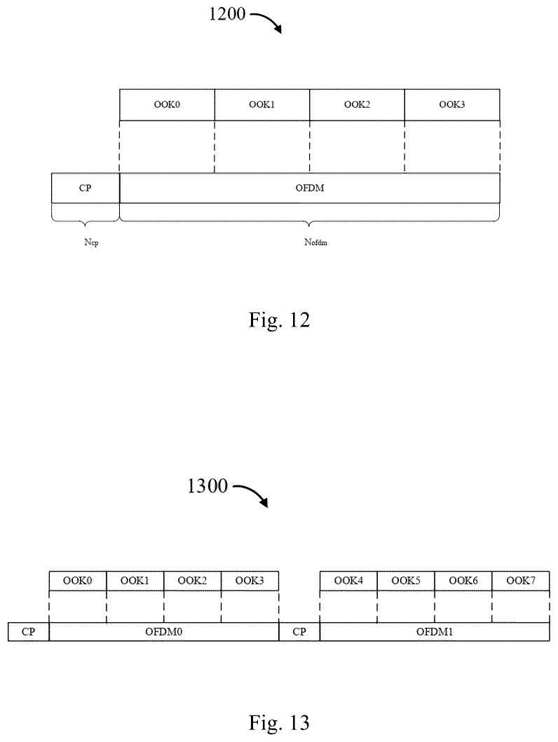

FIG. 12 illustrates an example diagram 1200 of an OOK sequence with a CP being handled as a useless part of an OOK symbol in accordance with some embodiments of the present disclosure. It is still assumed that the number of subcarriers used for the WUS is N_{wus}, the length of the OFDM symbol without CP is N_{ofdm} samples, and the length of CP is N_{cp}.

As shown in FIG. 12, the length of the k pre-DFT subsequences are same, and the length (denoted by N₂) can be provided as:

$${N}_{2} = {N}_{wus} / k . \qquad ( 8 )$$

If only one OFDM symbol is used to generate the WUS signal, then the WUS receiver only need to detect the k OOK symbols, and the CP will not lead to confusion in the detection. However, if multiple OFDM symbols are used to generate the WUS signal, there will be CP(s) in-between the OOK symbols, the WUS receiver has to identify which part of its received signal is CP.

FIG. 13 illustrates an example diagram 1300 of an OOK sequence that duration of a CP and duration of the OOK sequence are different. In some embodiments, multiple OOK symbols may be mapped into one OFDM symbol, and the CP may be inserted normally. Therefore, the duration of the CP can be seen as a useless part for the WUS signal, and the receiver should be able remove this part. However, as shown in FIG. 13, the duration of CP and the duration of a post-IFFT subsequence of an OOK symbol may be different. This may cause some difficulty for receiver.

In some embodiments, it may increase the receiver complexity to handle this non-uniform symbol duration issue. For example, the receiver may have relatively high oversampling rate, relatively fine time synchronization and relatively complex baseband processing.

In addition, the OOK sequence may be designed to facilitate the CP detection. For example, suppose two OOK subsequences are mapped to two OFDM symbols respectively, the second OOK subsequence could be a repetition of the first OOK subsequence. Alternatively, the two OOK subsequences may be generated based on a same sequence but multiplied with two sets of coefficients respectively (e.g., the two sets of coefficients are two orthogonal cover codes (OCCs) respectively). With these two methods, since the two OOK subsequences are correlated, then an auto-correlation detector may be applied to detect the CP part, which may have relatively low complexity.

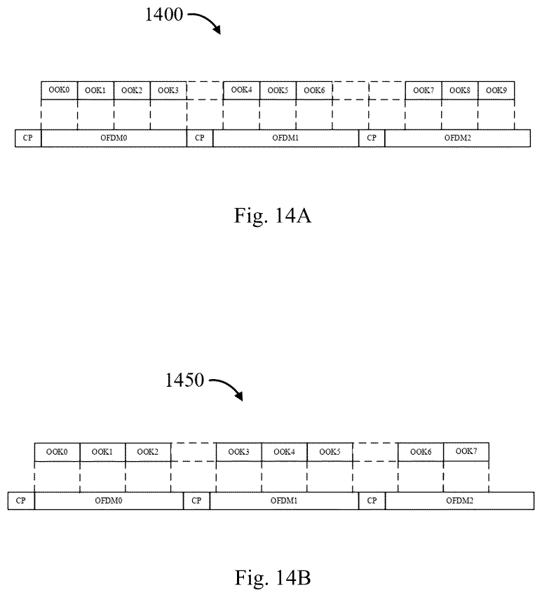

In some embodiments, “filling data” may be inserted at the initial or end part of the pre-DFT sequence. The purpose is to make the gap between two non-contiguous OOK symbols equals to an integer number of OOK symbol length. FIGS. 14A and 14B illustrate example diagrams of an OOK sequence with filling data inserted between non-contiguous OOK symbols. FIG. 14A is generally indicated as 1400, and FIG. 14B is generally indicated as 1450.

For example, in FIG. 14A, the OOK3 and OOK4 are non-contiguous, and the gap between them equals to the duration of an OOK symbol; the OOK6 and OOK7 are also non-contiguous, and the gap between them equals to the duration of two OOK symbols. In FIG. 14B, the OOK2 and OOK3 are non-contiguous, and the gap between them equals to the duration of an OOK symbol; the OOK5 and OOK6 are non-contiguous, and the gap between them also equals to the duration of an OOK symbol.

To make the gap between two non-contiguous OOK symbols equals to an integer number of OOK symbol length, a filling data sequence which include one or more filling data may be inserted at the initial part or the end part of the pre-DFT sequence. The filling data can be zero(s), or a predefined sequence, or a copy or transformation of a part of the pre-DFT sequence.

In some embodiments, the length of the filling data sequence may be determined based on the CP length and the index of the OFDM symbol in the OFDM symbols for WUS signal. For purpose of illustration without suggesting any limitations, suppose that L OFDM symbols are used for the WUS signal and the length of the post-IFFT subsequence for an OOK symbol is Nₒₒₖ, then, for the l-th (0<l<L) OFDM symbol, the length (denoted by N₄) of filling data sequence at the initial part of the pre-DFT sequence can be:

$${{N ’}_{4} = \{ ceil [ 1 * ( {N}_{ofdm} + {N}_{cp} ) / {N}_{ook} ] * {N}_{ook} - l * ( {N}_{ofdm} + {N}_{cp} ) \} * ( {N}_{wus} / {N}_{ofdm} ) , and {N}_{4} = N ’}_{4} , or \qquad ( 9 )$$

$${{N}_{4} = floor ( N ’}_{4} ) , or \qquad ( 10 )$$

$${{N}_{4} = ceil ( N ’}_{4} ) . \qquad ( 11 )$$

Length (denoted by N₅) of filling data sequence at the end part of the pre-DFT sequence can be:

$${{N ’}_{5} = \{ [ ( l + 1 ) * {N}_{ofdm} + l * {N}_{cp} ] - floor \{ [ ( l + 1 ) * {N}_{ofdm} + l * {N}_{cp} ] / {N}_{ook} \} * {N}_{ook} \} * ( {N}_{wus} / {N}_{ofdm} ) , and {N}_{5} = N ’}_{5} , or \qquad ( 12 )$$

$${{N}_{5} = floor ( N ’}_{5} ) , or \qquad ( 13 )$$

$${{N}_{5} = ceil ( N ’}_{5} ) . \qquad ( 14 )$$

Alternatively or in addition, an offset value may be configured. In this case, the length of filling data may be also determined based on the offset value. For example, the length values determined based on the above methods could plus or minus the offset value, or the offset value could be used in the above formulations.

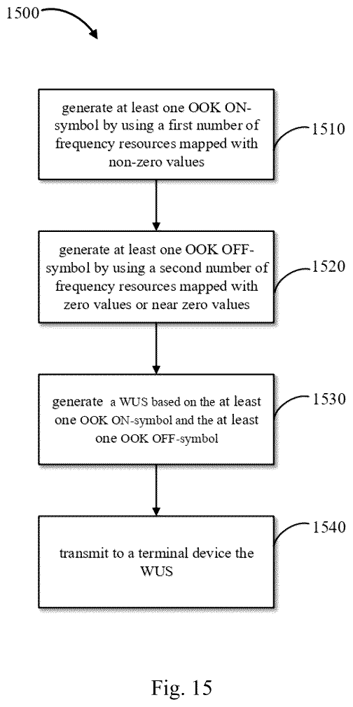

FIG. 15 illustrates a flowchart of an example method 1500 in accordance with some embodiments of the present disclosure. The method 1500 can be implemented at a network device, e.g., the network device 110 as shown in FIG. 1.

At block 1510, the network device 110 generates at least one OOK ON-symbol by using a first number of frequency resources mapped with non-zero values. The non-zero values are used for a normal DL transmission.

At block 1520, the network device 110 generates at least one OOK OFF-symbol by using a second number of frequency resources mapped with zero values or near zero values.

In some embodiments, the first number of frequency resources and the second number of frequency resources may comprise at least one of: the first multiple Physical Resource Blocks (PRBs) or subcarriers of a channel bandwidth, the last multiple PRBs or subcarriers of the channel bandwidth, or a guard band of the channel bandwidth.

At block 1530, the network device 110 generates a WUS based on the at least one OOK ON-symbol and the at least one OOK OFF-symbol. In some embodiments, the network device 110 may generate the WUS by using an OFDM operation. The OFDM operation can be used for generating the normal DL transmission.

In some embodiments, duration of the WUS may be associated with numerology for OFDM symbols. In some embodiments, the WUS may be mapped into the OFDM symbols in a subframe, and the WUS may be within one of the first half subframe, the first half subframe plus the first OFDM symbol of the second half subframe, or the second half subframe.

In some embodiments, the network device 110 may transmit a WUS configuration in a system information to the terminal device in RRC idle or inactive state. Alternatively or in addition, the network device 110 may transmit the WUS configuration via RRC signaling to the terminal device in RRC connected sate.

In some embodiments, the WUS configuration may comprise a frequency domain resource configuration. The frequency domain resource configuration may indicate a plurality of frequency resources that the WUS occupies. Alternatively or in addition, the WUS configuration may comprise a time domain resource configuration. The time domain resource configuration may indicate at least one of a periodicity of the WUS, a duty cycle of the WUS and a number of OOK symbols mapped into an OFDM symbol. The OOK symbols MAY comprise the at least one OOK ON-symbol and the at least one OOK OFF-symbol, and multiple continuous OFDM symbols in a slot or a subframe which are used for the WUS. Alternatively or in addition, the WUS configuration may comprise a sequence configuration. The sequence configuration may indicate at least one of a sequence length of the OOK symbols, duration of the OOK symbols, a sequence ID which indicates an OOK sequence from a plurality of predefined OOK sequences.

In some embodiments, the network device 110 may reserve a guard band between the WUS and the normal DL transmission. The guard band may be filled with one of the zero values or the near zero values, or values based on data of the normal DL transmission.

In some embodiments, the near zero values may have smaller power than the non-zero values.

At block 1540, the network device 110 transmits to a terminal device the WUS.

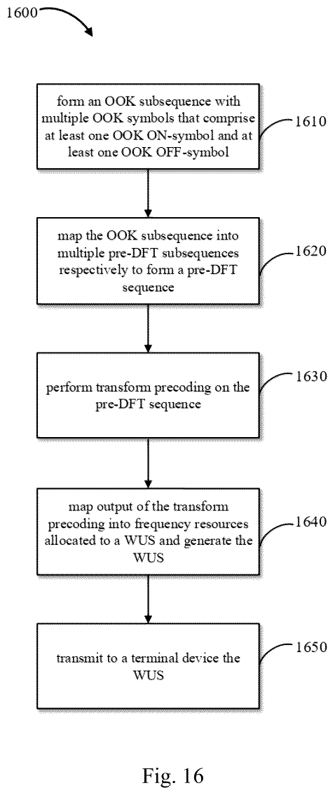

FIG. 16 illustrates a flowchart of an example method 1600 in accordance with some embodiments of the present disclosure. The method 1600 can be implemented at a network device, e.g., the network device 110 as shown in FIG. 1.

At block 1610, the network device 110 forms an OOK subsequence with multiple OOK symbols that comprise at least one OOK ON-symbol and at least one OOK OFF-symbol. The multiple OOK symbols are associated with one OFDM symbol.

At block 1620, the network device 110 maps the OOK subsequence into multiple pre-DFT subsequences respectively to form a pre-DFT sequence. Length of the pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In some embodiments, the network device 110 inserts filling data at initial or end part of the pre-DFT sequence. The filling data may be at least one of zeros, a predefined sequence, or a copy of a part of the pre-DFT subsequences. Length of the filling data may be determined based at least on one of: a CP length and an index of the OFDM symbol in multiple OFDM symbols, or an offset value.

At block 1630, the network device 110 performs transform precoding on the pre-DFT sequence.

At block 1640, the network device 110 maps output of the transform precoding into frequency resources allocated to a WUS and generates the WUS.

In some embodiments, the network device 110 may perform an IFFT operation on the output of the transform precoding and data for a normal DL transmission, and inserting a CP to output of the IFFT operation. Alternatively, the network device 110 may perform an IFFT operation on the output of the transform precoding, and insert a GI before front of output of the IFFT operation. Length of the GI may be same as a length of the CP. Moreover, the GI may be one of a zero value sample, a dedicated sequence, a copy or a transformation of a part of the output of the independent IFFT operation, or the CP.

In some embodiments, the length of the pre-DFT subsequence in the multiple pre-DFT subsequences may be further associated with at least one of: a length of the OFDM symbol without the CP and the length of the CP. Moreover, difference between a length of the first pre-DFT subsequence and any of the other pre-DFT subsequences may be associated with the length of the CP.

In some embodiments, the length of the first pre-DFT subsequence may be associated with at least one of: the length of the pre-DFT subsequences other than the first pre-DFT subsequence and the number of subcarriers used for the WUS.

In some embodiments, the output of the independent IFFT operation may comprise multiple post-IFFT subsequences. In accordance with a determination that the first OOK symbol of the multiple OOK symbols is an OOK ON-symbol, the network device 110 may generate a GI sequence based on the first post-IFFT subsequence of the multiple post-IFFT subsequences or the first post-IFFT subsequence with inversed order. Alternatively or in addition, in accordance with a determination that the first OOK symbol of the multiple OOK symbols is an OOK OFF-symbol, the network device 110 may generate a GI sequence with the zero values or near zero values. Alternatively or in addition, in accordance with a determination that the first OOK symbol and the last OOK symbol of the multiple OOK symbols are same, the network device 110 may generate a GI sequence with the last post-IFFT subsequence of the multiple post-IFFT subsequences.

In some embodiments, in accordance with a determination that multiple OOK subsequences are associated with multiple OFDM symbols, at least one of the multiple OOK subsequences may be a repetition of the first OOK subsequence of the multiple OOK subsequences. Alternatively or in addition, the multiple OOK subsequences may be generated based on a same sequence and multiplied with two sets of coefficients respectively.

At block 1650, the network device 110 transmits to a terminal device the WUS.

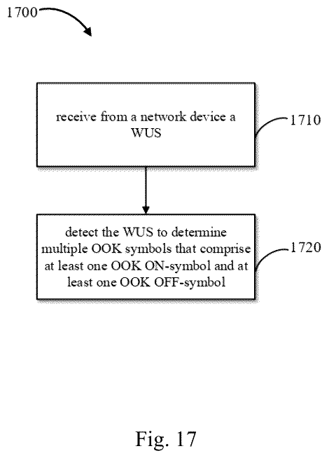

FIG. 17 illustrates a flowchart of an example method 1700 in accordance with some embodiments of the present disclosure. The method 1700 can be implemented at a terminal device, e.g., the terminal device 120 as shown in FIG. 1.

At block 1710, the terminal device 120 receives from a network device a WUS.

At block 1720, the terminal device 120 detects the WUS to determine multiple OOK symbols that comprise at least one OOK ON-symbol and at least one OOK OFF-symbol.

In some embodiments, the at least one OOK ON-symbol is generated based on a first number of frequency resources mapped with non-zero values. The non-zero values are used for a normal DL transmission. The at least one OOK OFF-symbol is generated based on a second number of frequency resources mapped with zero values or near zero values.

In some embodiments, the WUS may be generated based on an OFDM operation. The OFDM operation may be used for generating the normal DL transmission.

In some embodiments, in accordance with a determination that the terminal device is in Radio Resource Control (RRC) idle or inactive state, the terminal device may receive a WUS configuration in system information from the network device to monitor the WUS. Alternatively or in addition, in accordance with a determination that the terminal device is in RRC connected sate, the terminal device may receive a WUS configuration from the network device via RRC signaling. In some embodiments, the WUS configuration may comprise a frequency domain resource configuration. The frequency domain resource configuration may indicate a plurality of frequency resources that the WUS occupies. Alternatively or in addition, the WUS configuration may comprise a time domain resource configuration. The time domain resource configuration may indicate at least one of a periodicity of the WUS, a duty cycle of the WUS and a number of OOK symbols mapped into an OFDM symbol. The OOK symbols MAY comprise the at least one OOK ON-symbol and the at least one OOK OFF-symbol, and multiple continuous OFDM symbols in a slot or a subframe which are used for the WUS. Alternatively or in addition, the WUS configuration may comprise a sequence configuration. The sequence configuration may indicate at least one of a sequence length of the OOK symbols, duration of the OOK symbols, a sequence ID which indicates an OOK sequence from a plurality of predefined OOK sequences.

In some embodiments, in response to not receiving the WUS configuration from the network device 110, the terminal device 120 may detect the WUS based on an assumption that the plurality of frequency resources for the WUS is at least one of: multiple central PRBs of a default BWP, multiple upper-edge PRBs of the default BWP, multiple lower-edge PRBs of the default BWP, multiple central PRBs of a channel bandwidth, multiple upper-edge PRBs of the channel bandwidth, or multiple lower-edge PRBs of the channel bandwidth.

In some embodiments, the terminal device 120 may determine duration of the first OOK symbol of the multiple OOK symbols based at least on a boundary between the first and second OOK symbols of the multiple OOK symbols.

In some embodiments, the non-zero values may comprise data of the normal DL transmission.

In some embodiments, the terminal device 120 may determine a guard band reserved between the WUS and the normal DL transmission. The guard band may be filled with one of: the zero values or near zero values, or values that are based on data of the normal DL transmission.

In some embodiments, the near zero values may have smaller power than the non-zero values.

In some embodiments, the WUS is generated based on an output of transform precoding of a pre-DFT sequence, and the pre-DFT sequence comprises multiple pre-DFT subsequences. The pre-DFT sequence is generated based on an OOK subsequence, and the OOK subsequence comprises the multiple OOK symbols. The multiple OOK symbols are associated with one OFDM symbol. Moreover, length of a pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In some embodiments, the terminal device 120 may receive the WUS and a normal downlink (DL) transmission in a DL signal.

In some embodiments, the WUS and the normal DL transmission may be generated by an IFFT operation, and a CP may be inserted to the output of the IFFT operation. Alternatively or in addition, the WUS may be generated by an independent IFFT operation, and a GI may be inserted to the output of the independent IFFT operation.

In some embodiments, the length of the pre-DFT subsequence in the multiple pre-DFT subsequences may be associated to at least on one of a length of the OFDM symbol without the CP and the length of the CP. Difference between length of the first pre-DFT subsequence and any of the other pre-DFT subsequences may be associated with the length of the CP.

In some embodiments, the length of the first pre-DFT subsequence may be associated with at least one of: the length of the pre-DFT subsequences other than the first pre-DFT subsequence and the number of subcarriers used for the WUS.

In some embodiments, the output of the independent IFFT operation may comprise multiple post-IFFT subsequences. In accordance with a determination that the first OOK symbol of the multiple OOK symbols is an OOK ON-symbol, a GI sequence may be generated based on the first post-IFFT subsequence of the multiple post-IFFT subsequences or the first post-IFFT subsequence with inversed order. Alternatively or in addition, in accordance with a determination that the first OOK symbol of the multiple OOK symbols is an OOK OFF-symbol, a GI sequence may be generated based on zero values or near zero values. Alternatively or in addition, in accordance with a determination that the first OOK symbol and the last OOK symbol of the multiple OOK symbols are same, a GI sequence may be generated based on the last post-IFFT subsequence of the multiple post-IFFT subsequences.

In some embodiments, at least one of multiple OOK subsequences may be a repetition of the first OOK subsequence of the multiple OOK subsequences. Alternatively or in addition, the multiple OOK subsequences may be generated based on a same sequence and multiplied with two sets of coefficients respectively.

In some embodiments, the WUS may be generated based on an output of transform precoding of a Pre-DFT sequence with filling data inserted at initial or end part of the pre-DFT sequence. The filling data may be at least one of: zeros, a predefined sequence, or a copy of a part of the pre-DFT subsequences. Length of the filling data sequence may be determined based at least on one of: a CP length and an index of the OFDM symbol in multiple OFDM symbols, or an offset value.

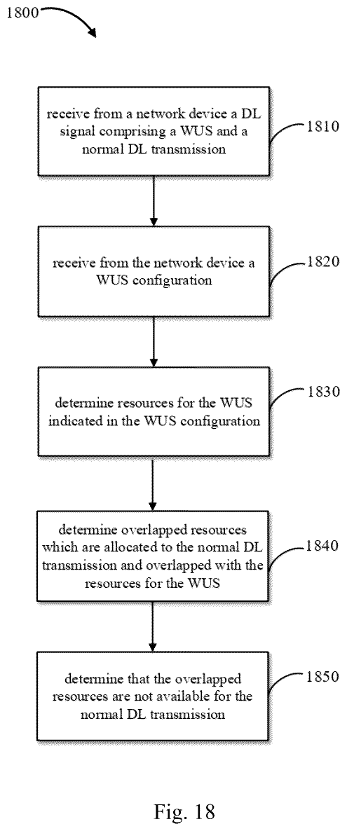

FIG. 18 illustrates a flowchart of an example method 1800 in accordance with some embodiments of the present disclosure. The method 1800 can be implemented at a terminal device, e.g., the terminal device 121 as shown in FIG. 1.

At block 1810, the terminal device 121 receives from a network device a DL signal comprising a WUS and a normal DL transmission. The LP-WUS and the normal DL transmission are generated using an OFDM operation.

At block 1820, the terminal device 121 receives from the network device a WUS configuration.

In some embodiments, the WUS may comprise multiple OOK symbols. Moreover, the WUS configuration may comprise a frequency domain resource configuration. The frequency domain resource configuration may indicate a plurality of frequency resources that the WUS occupies. Alternatively or in addition, the WUS configuration may comprise a time domain resource configuration. The time domain resource configuration may indicate at least one of a periodicity of the WUS, a duty cycle of the WUS and a number of OOK symbols mapped into an OFDM symbol. The OOK symbols MAY comprise the at least one OOK ON-symbol and the at least one OOK OFF-symbol, and multiple continuous OFDM symbols in a slot or a subframe which are used for the WUS. Alternatively or in addition, the WUS configuration may comprise a sequence configuration. The sequence configuration may indicate at least one of a sequence length of the OOK symbols, duration of the OOK symbols, a sequence ID which indicates an OOK sequence from a plurality of predefined OOK sequences.

At block 1830, the terminal device 121 determines resources for the WUS indicated in the WUS configuration.

At block 1840, the terminal device 121 determines overlapped resources which are allocated to the normal DL transmission and overlapped with the resources for the WUS.

At block 1850, the terminal device 121 determines determining that the overlapped resources are not available for the normal DL transmission.

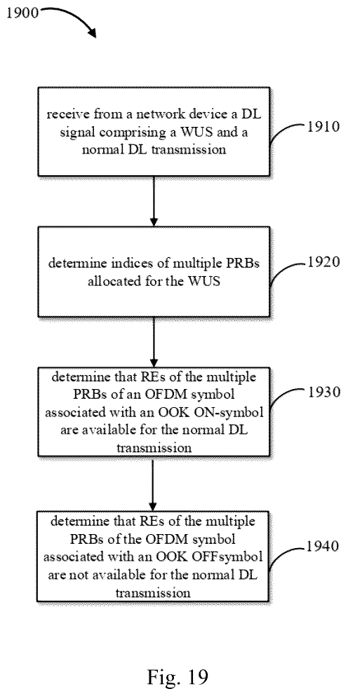

FIG. 19 illustrates a flowchart of an example method 1900 in accordance with some embodiments of the present disclosure. The method 1900 can be implemented at a terminal device, e.g., the terminal device 121 as shown in FIG. 1.

At block 1910, the terminal device 121 receives from a network device a DL signal comprising a WUS and a normal DL transmission. The WUS may comprise multiple OOK symbols comprising at least one OOK ON-symbol and at least one OOK OFF-symbol. The at least one OOK ON-symbol is generated based on data of the normal DL transmission.

At block 1920, the terminal device 121 determines indices of multiple PRBs allocated to the WUS.

At block 1930, the terminal device 121 determines that REs of the multiple PRBs of an OFDM symbol associated with an OOK ON-symbol are available for the normal DL transmission.

At block 1940, the terminal device 121 determines that REs of the multiple PRBs of the OFDM symbol associated with an OOK OFF-symbol are not available for the normal DL transmission.

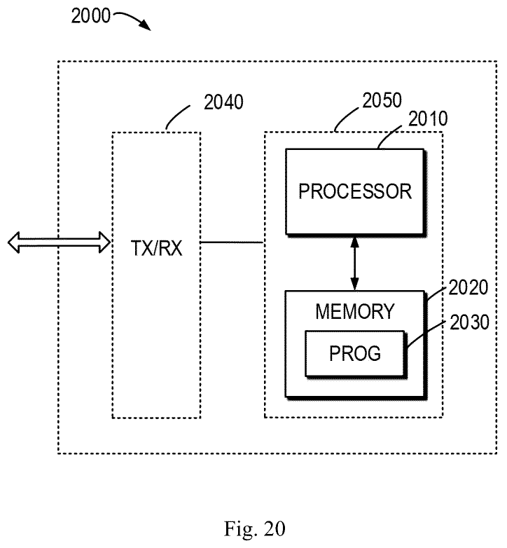

FIG. 20 is a simplified block diagram of a device 2000 that is suitable for implementing some embodiments of the present disclosure. The device 2000 can be considered as a further example embodiment of the network device 110 or the terminal devices 120 and 121 as shown in FIG. 1. Accordingly, the device 2000 can be implemented at or as at least a part of the network device 110 or the terminal devices 120 and 121.

As shown, the device 2000 includes a processor 2010, a memory 2020 coupled to the processor 2010, a suitable transmitter (TX) and receiver (RX) 2040 coupled to the processor 2010, and a communication interface coupled to the TX/RX 2040. The memory 2020 stores at least a part of a program 2030. The TX/RX 2040 is for bidirectional communications. The TX/RX 2040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 2030 is assumed to include program instructions that, when executed by the associated processor 2010, enable the device 2000 to operate in accordance with the embodiments of the present disclosure, as discussed herein with reference to FIGS. 1 to 19. The embodiments herein may be implemented by computer software executable by the processor 2010 of the device 2000, or by hardware, or by a combination of software and hardware. The processor 2010 may be configured to implement various embodiments of the present disclosure. Furthermore, a combination of the processor 2010 and memory 2020 may form processing means 2050 adapted to implement various embodiments of the present disclosure.

The memory 2020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 2020 is shown in the device 2000, there may be several physically distinct memory modules in the device 2000. The processor 2010 may be of any type suitable to the local technical network, and may include one or more of general purpose computers, special purpose computers, microprocessors, digital signal processors (DSPs) and processors based on multicore processor architecture, as non-limiting examples. The device 2000 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 19. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A method implemented at a network device, comprises: generating at least one On-Off Keying (OOK) ON-symbol by using a first number of frequency resources mapped with non-zero values, wherein the non-zero values are used for a normal downlink (DL) transmission; generating at least one OOK OFF-symbol by using a second number of frequency resources mapped with zero values or near zero values; generating a Wake-up Signal (WUS) based on the at least one OOK ON-symbol and the at least one OOK OFF-symbol; and transmitting to a terminal device the WUS.

In some embodiments, generating the WUS comprises: generating the WUS by using an Orthogonal Frequency Division Multiplexing (OFDM) operation. The OFDM operation is used for generating the normal DL transmission.

In some embodiments, the first number of frequency resources and the second number of frequency resources comprise at least one of the following: the first multiple Physical Resource Blocks (PRBs) or subcarriers of a channel bandwidth, the last multiple PRBs or subcarriers of the channel bandwidth, or a guard band of the channel bandwidth.

In some embodiments, duration of the WUS is associated with numerology for OFDM symbols.

In some embodiments, the WUS is mapped into the OFDM symbols in a subframe. The WUS is within one of the following: the first half subframe, the first half subframe plus the first OFDM symbol of the second half subframe, or the second half subframe.

In some embodiments, the method as described above further comprises one of the following: transmitting a WUS configuration in a system information to the terminal device in Radio Resource Control (RRC) idle or inactive state; or transmitting the WUS configuration via RRC signaling to the terminal device in RRC connected sate. The WUS configuration comprises at least one of the following: a frequency domain resource configuration, indicating a plurality of frequency resources that the WUS occupies; a time domain resource configuration, indicating at least one of a periodicity of the WUS, a duty cycle of the WUS and a number of OOK symbols mapped into an OFDM symbol, where the OOK symbols comprises the at least one OOK ON-symbol and the at least one OOK OFF-symbol, and multiple continuous OFDM symbols in a slot or a subframe which are used for the WUS; and a sequence configuration, indicating at least one of a sequence length of the OOK symbols, duration of the OOK symbols, a sequence ID which indicates an OOK sequence from a plurality of predefined OOK sequences.

In some embodiments, the method as described above further comprises reserving a guard band between the WUS and the normal DL transmission. The guard band is filled with one of the following: the zero values or the near zero values, or values based on data of the normal DL transmission.

In some embodiments, the near zero values have smaller power than the non-zero values.

In another solution, a method implemented at a network device, comprises: forming an OOK subsequence with multiple OOK symbols that comprise at least one OOK ON-symbol and at least one OOK OFF-symbol, wherein the multiple OOK symbols are associated with one OFDM symbol; mapping the OOK subsequence into multiple pre-Discrete Fourier Transform (pre-DFT) subsequences respectively to form a pre-DFT sequence; performing transform precoding on the pre-DFT sequence; mapping output of the transform precoding into frequency resources allocated to a Wake-up Signal (WUS) and generating the WUS; and transmitting to a terminal device the WUS; wherein length of the pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In some embodiments, generating the WUS further comprises one of the following: performing an Inverse Fast Fourier Transform (IFFT) operation on the output of the transform precoding and data for a normal DL transmission, and inserting a Cyclic Prefix (CP) to output of the IFFT operation; or performing an IFFT operation on the output of the transform precoding, and inserting a Guard Interval (GI) before front of output of the IFFT operation, wherein length of the GI is same as a length of the CP, and wherein the GI is one of a zero value sample, a dedicated sequence, a copy or a transformation of a part of the output of the independent IFFT operation, or the CP.

In some embodiments, the length of the pre-DFT subsequence in the multiple pre-DFT subsequences is further associated with at least one of: a length of the OFDM symbol without the CP and the length of the CP. Difference between a length of the first pre-DFT subsequence and any of the other pre-DFT subsequences is associated with the length of the CP.

In some embodiments, the length of the first pre-DFT subsequence is associated with at least one of: the length of the pre-DFT subsequences other than the first pre-DFT subsequence and the number of subcarriers used for the WUS.

In some embodiments, the output of the independent IFFT operation comprises multiple post-IFFT subsequences. Inserting the GI comprises one of the following: in accordance with a determination that the first OOK symbol of the multiple OOK symbols is an OOK ON-symbol, generating a GI sequence based on the first post-IFFT subsequence of the multiple post-IFFT subsequences or the first post-IFFT subsequence with inversed order; in accordance with a determination that the first OOK symbol of the multiple OOK symbols is an OOK OFF-symbol, generating a GI sequence with the zero values or near zero values; or in accordance with a determination that the first OOK symbol and the last OOK symbol of the multiple OOK symbols are same, generating a GI sequence with the last post-IFFT subsequence of the multiple post-IFFT subsequences.

In some embodiments, in accordance with a determination that multiple OOK subsequences are associated with multiple OFDM symbols, at least one of the multiple OOK subsequences is a repetition of the first OOK subsequence of the multiple OOK subsequences, or the multiple OOK subsequences are generated based on a same sequence and multiplied with two sets of coefficients respectively.

In some embodiments, forming the pre-DFT sequence further comprises: inserting filling data at initial or end part of the pre-DFT sequence. The filling data is at least one of zeros, a predefined sequence, or a copy of a part of the pre-DFT subsequences. Length of the filling data is determined based at least on one of: a CP length and an index of the OFDM symbol in multiple OFDM symbols, or an offset value.

In another solution, a network device comprises a processor; and a memory coupled to the processor and storing instructions thereon, the instructions, when executed by the processor, causing the network device to perform the methods as summarized above.

In another solution, a method implemented at a terminal device, comprises: receiving from a network device a Wake-up Signal (WUS); and detecting the WUS to determine multiple On-Off Keying (OOK) symbols that comprise at least one OOK ON-symbol and at least one OOK OFF-symbol, wherein the at least one OOK ON-symbol is generated based on a first number of frequency resources mapped with non-zero values, the non-zero values used for a normal downlink (DL) transmission, and wherein the at least one OOK OFF-symbol is generated based on a second number of frequency resources mapped with zero values or near zero values.

In some embodiments, the WUS is generated based on an Orthogonal Frequency Division Multiplexing (OFDM) operation. The OFDM operation is used for generating the normal DL transmission.

In some embodiments, the method as described above further comprises: in accordance with a determination that the terminal device is in Radio Resource Control (RRC) idle or inactive state, receiving a WUS configuration in a system information from the network device to monitor the WUS; or in accordance with a determination that the terminal device is in RRC connected sate, receiving a WUS configuration from the network device via RRC signaling. The WUS configuration comprises at least one of the following: a frequency domain resource configuration, indicating a plurality of frequency resources that the WUS occupies; a time domain resource configuration, indicating at least one of a periodicity of the WUS, a duty cycle of the WUS and a number of OOK symbols mapped into an OFDM symbol, where the OOK symbols comprises the at least one OOK ON-symbol and the at least one OOK OFF-symbol, and multiple continuous OFDM symbols in a slot or a subframe which are used for the WUS; and a sequence configuration, indicating at least one of a sequence length of the OOK symbols, duration of the OOK symbols, a sequence ID which indicates an OOK sequence from a plurality of predefined OOK sequences.

In some embodiments, in response to not receiving the WUS configuration from the network device, detecting the WUS is based on an assumption that the plurality of frequency resources for the WUS is at least one of the following: multiple central Physical Resource Blocks (PRBs) of a default Bandwith Part (BWP), multiple upper-edge PRBs of the default BWP, multiple lower-edge PRBs of the default BWP, multiple central PRBs of a channel bandwidth, multiple upper-edge PRBs of the channel bandwidth, or multiple lower-edge PRBs of the channel bandwidth.

In some embodiments, detecting the WUS comprises: determining duration of the first OOK symbol of the multiple OOK symbols based at least on a boundary between the first and second OOK symbols of the multiple OOK symbols.

In some embodiments, detecting the WUS comprises: determining a guard band reserved between the WUS and the normal DL transmission. The guard band is filled with one of the following: the zero values or near zero values, or values that are based on data of the normal DL transmission.

In some embodiments, the near zero values have smaller power than the non-zero values.

In another solution, a method implemented at a terminal device, comprises: receiving from a network device a Wake-up Signal (WUS); and detecting the WUS to determine multiple On-Off Keying (OOK) symbols that comprise at least one OOK ON-symbol and at least one OOK OFF-symbol. The WUS is generated based on an output of transform precoding of a pre-Discrete Fourier Transform (pre-DFT) sequence, the pre-DFT sequence comprises multiple pre-DFT subsequences, the pre-DFT sequence is generated based on an OOK subsequence, and the OOK subsequence comprises the multiple OOK symbols, and wherein the multiple OOK symbols are associated with one OFDM symbol. Length of a pre-DFT subsequence in the multiple pre-DFT subsequences is associated with at least one of: a number of subcarriers used for the WUS, a number of the multiple OOK symbols, or an index of the pre-DFT subsequence in the multiple pre-DFT subsequences.

In some embodiments, receiving the WUS comprises receiving the WUS and a normal downlink (DL) transmission in a DL signal.

In some embodiments, the WUS and the normal DL transmission are generated by an Inverse Fast Fourier Transform (IFFT) operation, and a Cyclic Prefix (CP) is inserted to the output of the IFFT operation; or the WUS is generated by an independent IFFT operation, and a Guard Interval (GI) is inserted to the output of the independent IFFT operation.

In some embodiments, the length of the pre-DFT subsequence in the multiple pre-DFT subsequences is further associated to at least on one of: a length of the OFDM symbol without the CP and the length of the CP. Difference between length of the first pre-DFT subsequence and any of the other pre-DFT subsequences is associated with the length of the CP.

In some embodiments, the length of the first pre-DFT subsequence is associated with at least one of: the length of the pre-DFT subsequences other than the first pre-DFT subsequence and the number of subcarriers used for the WUS.

In some embodiments, the output of the independent IFFT operation comprises multiple post-IFFT subsequences. The GI is generated based on one of the following: in accordance with a determination that the first OOK symbol of the multiple OOK symbols is an OOK ON-symbol, a GI sequence is generated based on the first post-IFFT subsequence of the multiple post-IFFT subsequences or the first post-IFFT subsequence with inversed order; in accordance with a determination that the first OOK symbol of the multiple OOK symbols is an OOK OFF-symbol, a GI sequence is generated based on zero values or near zero values; or in accordance with a determination that the first OOK symbol and the last OOK symbol of the multiple OOK symbols are same, a GI sequence is generated based on the last post-IFFT subsequence of the multiple post-IFFT subsequences.

In some embodiments, at least one of multiple OOK subsequences is a repetition of the first OOK subsequence of the multiple OOK subsequences; or the multiple OOK subsequences are generated based on a same sequence and multiplied with two sets of coefficients respectively.

In some embodiments, the WUS is generated based on an output of transform precoding of a Pre-DFT sequence with filling data inserted at initial or end part of the pre-DFT sequence. The filling data is at least one of: zeros, a predefined sequence, or a copy of a part of the pre-DFT subsequences. Length of the filling data sequence is determined based at least on one of: a CP length and an index of the OFDM symbol in multiple OFDM symbols, or an offset value.

In another solution, a method implemented at a terminal device, comprises: receiving from a network device a downlink (DL) signal comprising a Wake-up Signal (WUS) and a normal DL transmission, wherein the LP-WUS and the normal DL transmission are generated using an Orthogonal Frequency Division Multiplexing (OFDM) operation; receiving from the network device a WUS configuration; determining resources for the WUS indicated in the WUS configuration; determining overlapped resources which are allocated to the normal DL transmission and overlapped with the resources for the WUS; and determining that the overlapped resources are not available for the normal DL transmission.

In some embodiments, the WUS comprises multiple On-Off Keying (OOK) symbols. The WUS configuration comprises at least one of the following: a frequency domain resource configuration, indicating a plurality of frequency resources that the WUS occupies; a time domain resource configuration, indicating at least one of a periodicity of the WUS, a duty cycle of the WUS and a number of OOK symbols mapped into an OFDM symbol, where the OOK symbols comprises the at least one OOK ON-symbol and the at least one OOK OFF-symbol, and multiple continuous OFDM symbols in a slot or a subframe which are used for the WUS; and a sequence configuration, indicating at least one of a sequence length of the OOK symbols, duration of the OOK symbols, a sequence ID which indicates an OOK sequence from a plurality of predefined OOK sequences.

In another solution, a method implemented at a terminal device, comprises: receiving from a network device a downlink (DL) signal comprising a Wake-up Signal (WUS) and a normal DL transmission, wherein the WUS comprises multiple On-Off Keying (OOK) symbols comprising at least one OOK ON-symbol and at least one OOK OFF-symbol, and wherein the at least one OOK ON-symbol is generated based on data of the normal DL transmission; determining indices of multiple PRBs allocated to the WUS; determining that Resource Elements (REs) of the multiple PRBs of an OFDM symbol associated with an OOK ON-symbol are available for the normal DL transmission; and determining that REs of the multiple PRBs of the OFDM symbol associated with an OOK OFF-symbol are not available for the normal DL transmission.

In another solution, a terminal device comprises a processor; and a memory coupled to the processor and storing instructions thereon, the instructions, when executed by the processor, causing the terminal device to perform the methods as summarized above.

In another solution, a computer readable medium have instructions stored thereon, the instructions, when executed on at least one processor, causing the at least one processor to perform the methods as summarized above.

1-20. (canceled)

21. A method implemented at a network device, comprising:
forming an On-Off Keying (OOK) subsequence with one or multiple OOK symbols, wherein an OOK symbol in the one or multiple OOK symbols is an OOK ON-symbol or an OOK OFF-symbol, wherein the one or multiple OOK symbols are associated with one Orthogonal Frequency Division Multiplexing (OFDM) symbol;
mapping the OOK subsequence into one pre-Discrete Fourier Transform (pre-DFT) subsequence to form a pre-DFT sequence in a case where the OOK subsequence comprises one OOK symbol and the OOK symbol is an OOK-ON symbol, wherein the one pre-DFT subsequence is generated based on a Zadoff-Chu (ZC) sequence; and
generating a Wake-up Signal (WUS) based on the pre-DFT sequence.

22. The method of claim 21, further comprising:
mapping the OOK subsequence into multiple pre-DFT subsequences respectively to form a pre-DFT sequence in a case where the OOK subsequence comprises multiple OOK symbols, wherein a pre-DFT subsequence that associated with an OOK ON-symbol in the multiple pre-DFT subsequences is generated based on a ZC sequence, wherein a length of the pre-DFT subsequence in the multiple pre-DFT subsequences is associated with a number of the multiple OOK symbols.

23. The method of claim 21, further comprising:
performing transform precoding on the pre-DFT sequence;
mapping output of the transform precoding into frequency resources allocated to the WUS.

24. The method of claim 23, wherein generating the WUS further comprises one of the following:
performing an Inverse Fast Fourier Transform (IFFT) operation on the output of the transform precoding and data for a normal DL transmission, and inserting a Cyclic Prefix (CP) to output of the IFFT operation; or
performing an IFFT operation on the output of the transform precoding, and inserting a Guard Interval (GI) before front of output of the IFFT operation, wherein a length of the GI is same as a length of the CP, and wherein the GI is one of a zero value sample, a dedicated sequence, a copy or a transformation of a part of the output of the independent IFFT operation, or the CP.

25. The method of claim 24, wherein:
the length of the pre-DFT subsequence in the multiple pre-DFT subsequences is further associated with at least one of: a length of the OFDM symbol without the CP and the length of the CP; and
difference between a length of a first pre-DFT subsequence in the multiple pre-DFT subsequences and any of the other pre-DFT subsequences in the multiple pre-DFT subsequences is associated with the length of the CP.

26. The method of claim 25, wherein the length of the first pre-DFT subsequence is associated with at least one of: the length of the multiple pre-DFT subsequences other than the first pre-DFT subsequence and the number of subcarriers used for the WUS.

27. The method of claim 24, wherein the output of the independent IFFT operation comprises multiple post-IFFT subsequences, and wherein inserting the GI comprises one of the following:
generating a GI sequence based on the first post-IFFT subsequence of the multiple post-IFFT subsequences or the first post-IFFT subsequence with inversed order in a case where the first OOK symbol of the multiple OOK symbols is an OOK ON-symbol,
generating a GI sequence with the zero values or near zero values in a case where the first OOK symbol of the multiple OOK symbols is an OOK OFF-symbol, or
generating a GI sequence with the last post-IFFT subsequence of the multiple post-IFFT subsequences in a case where the first OOK symbol and the last OOK symbol of the multiple OOK symbols are same.

28. The method of claim 21, in accordance with a determination that multiple OOK subsequences are associated with multiple OFDM symbols, wherein:
at least one of the multiple OOK subsequences is a repetition of the first OOK subsequence of the multiple OOK subsequences, or
the multiple OOK subsequences are generated based on a same sequence and multiplied with two sets of coefficients respectively.

29. The method of claim 21, wherein forming the pre-DFT sequence comprises:
inserting filling data at initial or end part of the pre-DFT sequence,
wherein the filling data is at least one of zeros, a predefined sequence, or a copy of a part of the pre-DFT subsequences, and wherein length of the filling data is determined based at least on one of: a CP length and an index of the OFDM symbol in multiple OFDM symbols, or an offset value.

30. A method implemented at a terminal device, comprising:
receiving from a network device a Wake-up Signal (WUS); and
detecting the WUS to determine one or multiple On-Off Keying (OOK) symbols, wherein an OOK symbol in the one or multiple symbols is an OOK ON-symbol or an OOK OFF-symbol, the one or multiple OOK symbols are associated with one Orthogonal Frequency Division Multiplexing (OFDM) symbol, the one or multiple OOK symbols are comprised in an OOK subsequence, the WUS is generated based on a pre-Discrete Fourier Transform (pre-DFT) sequence;
wherein the pre-DFT sequence is formed by one pre-DFT subsequence which is mapped from the OOK subsequence in a case where the OOK subsequence comprises one OOK symbol and the OOK symbol is an OOK-ON symbol, the one pre-DFT subsequence is generated based on a Zadoff-Chu (ZC) sequence.

31. The method of claim 30, wherein the pre-DFT sequence is formed by multiple pre-DFT subsequences which is mapped from the OOK subsequence in a case where the OOK subsequence comprises multiple OOK symbols, wherein a pre-DFT subsequence that associated with an OOK ON-symbol in the multiple pre-DFT subsequences is generated based on a ZC sequence, wherein a length of the pre-DFT subsequence in the multiple pre-DFT subsequences is associated with a number of the multiple OOK symbols.

32. The method of claim 30, wherein receiving the WUS comprises receiving the WUS and a normal downlink (DL) transmission in a DL signal.

33. The method of claim 32, wherein:
the WUS and the normal DL transmission are generated by an Inverse Fast Fourier Transform (IFFT) operation, and a Cyclic Prefix (CP) is inserted to the output of the IFFT operation; or
the WUS is generated by an independent IFFT operation, and a Guard Interval (GI) is inserted to the output of the independent IFFT operation.

34. The method of claim 31, wherein the length of the pre-DFT subsequence in the multiple pre-DFT subsequences is further associated to at least on one of: a length of the OFDM symbol without the CP and the length of the CP, and
wherein difference between length of a first pre-DFT subsequence in the multiple pre-DFT subsequences and any of the other pre-DFT subsequences in the multiple pre-DFT subsequences is associated with the length of the CP.

35. The method of claim 34, wherein the length of the first pre-DFT subsequence is associated with at least one of: the length of the pre-DFT subsequences other than the first pre-DFT subsequence and the number of subcarriers used for the WUS.

36. The method of claim 30, wherein the output of the independent IFFT operation comprises multiple post-IFFT subsequences, and wherein the GI is generated based on one of the following:
a GI sequence is generated based on the first post-IFFT subsequence of the multiple post-IFFT subsequences or the first post-IFFT subsequence with inversed order in a case where the first OOK symbol of the multiple OOK symbols is an OOK ON-symbol,
a GI sequence is generated based on zero values or near zero values in a case where the first OOK symbol of the multiple OOK symbols is an OOK OFF-symbol, or
a GI sequence is generated based on the last post-IFFT subsequence of the multiple post-IFFT subsequences in a case where the first OOK symbol and the last OOK symbol of the multiple OOK symbols are same.

37. The method of claim 32, wherein:
at least one of multiple OOK subsequences is a repetition of the first OOK subsequence of the multiple OOK subsequences; or
the multiple OOK subsequences are generated based on a same sequence and multiplied with two sets of coefficients respectively.

38. The method of claim 32, wherein the WUS is generated based on an output of transform precoding of a Pre-DFT sequence with filling data inserted at initial or end part of the pre-DFT sequence, and
wherein the filling data is at least one of: zeros, a predefined sequence, or a copy of a part of the pre-DFT subsequences, and wherein length of the filling data sequence is determined based at least on one of: a CP length and an index of the OFDM symbol in multiple OFDM symbols, or an offset value.

39. A network device, comprising:
a processor configured to cause the network device to:
form an On-Off Keying (OOK) subsequence with one or multiple OOK symbols, wherein an OOK symbol in the one or multiple OOK symbols is an OOK ON-symbol or an OOK OFF-symbol, wherein the one or multiple OOK symbols are associated with one Orthogonal Frequency Division Multiplexing (OFDM) symbol;
map the OOK subsequence into one pre-Discrete Fourier Transform (pre-DFT) subsequence to form a pre-DFT sequence in a case where the OOK subsequence comprises one OOK symbol and the OOK symbol is an OOK-ON symbol, wherein the one pre-DFT subsequence is generated based on a Zadoff-Chu (ZC) sequence; and
generate a Wake-up Signal (WUS) based on the pre-DFT sequence.
